(19) United States
(12) Patent Application Publication
(10) Pub. No.: US 2023/0399527 A1
(43) Pub. Date: Dec. 14, 2023

(54) LAMINATE, HEAT-SENSITIVE RECORDING BODY, AND METHOD FOR FORMING IMAGE

(71) Applicant: TOYO INK SC HOLDINGS CO., LTD., Tokyo (JP)

(72) Inventors: Takaaki KOIKE, Chuo-ku, Tokyo (JP); Naoki KISHIMOTO, Chuo-ku, Tokyo (JP); Michitaka MAMIYA, Chuo-ku, Tokyo (JP)

(73) Assignee: TOYO INK SC HOLDINGS CO., LTD., Tokyo (JP)

(21) Appl. No.: 18/034,885

(22) PCT Filed: Nov. 9, 2021
(86) PCT No.: PCT/JP2021/041143

§ 371 Date: May 2, 2023

(30) Foreign Application Priority Data
Nov. 17, 2020 (JP) 2020-191240

(51) Int. Cl. C09D 5/26; C09D 5/00; C09D 5/29; C09D 7/40; C09D 7/61; C09D 133/06; C09D 175/12; B41M 5/40

(52) U.S. Cl. CPC C09D 5/26; C09D 5/002; C09D 5/29; C09D 7/70; C09D 7/61; C09D 133/064; C09D 133/068; C09D 175/12; B41M 5/40

(57) ABSTRACT

A laminate according to the present invention comprises, in the following order: a substrate (3); a primer layer (2) formed from a resin; and a colloidal crystal layer (1) that develops color due to light interference, wherein the resin, which forms the primer layer (2), has a glass transition point in the range of −35 to 100° C., the colloidal crystal layer (1) includes core-shell-type resin fine particles (4) and achromatic black fine particles (8), and has voids (7). The core-shell-type resin fine particles (4) each include a shell in an amount of 10-150 mass % with respect to the mass of a core, and the shell has a glass transition point in the range of −60 to 40° C. The colloidal crystal layer (1) has a thickness in the range of 0.5-100 μm.

### TECHNICAL FIELD

The present invention relates to a laminate having a colloidal crystal layer that develops color due to light interference and a heat-sensitive recording body formed using the laminate.

### BACKGROUND ART

Colloidal crystals in which particles are regularly arranged are being actively studied as one type of photonic crystals that exhibit specific optical properties such as structural color known as Bragg reflection and a light confinement effect using photonic band gaps. Colloidal crystals are photonic crystals that can be produced relatively easily, but it is difficult to fix them while maintaining an excellent color development property, and a technique for mass production of colloidal crystal coatings has not yet been achieved. In addition, development of materials that respond to external stimuli such as heat using colloidal crystals is being investigated, but there are problems such as unclear color development change of coatings and various poor coating resistances.

Patent Literature 1 discloses a laminate obtained by forming and fixing a colloidal crystal layer containing a binder component on a substrate on which a primer layer is formed. The laminate containing the colloidal crystal layer is heated by infrared laser emission, thermoplastic resin fine particles in the colloidal crystal are deformed, and color development changes. However, the laminate has a large deviation in the distribution of the binder component in the colloidal crystal layer, the bond between particles becomes weak, and the colloidal crystal layer easily collapses. In addition, the adhesion between the primer layer and the colloidal crystal layer is poor and interfacial separation is likely to occur. Therefore, for example, when a heat treatment is performed using a printer including a thermal head or the like, the colloidal crystal layer is scraped off in a part with which the head is in contact, and it is difficult to form an image. In addition, also in parts that have been heated, cracks are likely to occur in the coating, and various coating resistances are poor.

Patent Literature 2 discloses a colloidal crystal layer in which an elastomer precursor is poured into voids in the colloidal crystal layer and the voids are replaced with a resin component.

Patent Literature 3 discloses a colloidal crystal layer in which core-shell-type resin fine particles having a shell layer with film-forming properties and a core layer that maintains the particle shape are used as colloidal crystals, and voids are completely filled with fluidized shells.

The colloidal crystal layers described in Patent Literature 2 and 3 have excellent film resistance because the void parts are replaced with a resin component. However, since the difference in refractive index between the particle and the matrix component is small, excellent color development cannot be exhibited with a thin film. In addition, the color development does not change according to a heat treatment.

Patent Literature 4 discloses a colloidal crystal layer in which colloidal crystals having an inverse opal structure are used, and the particle part is composed of a fusible substance, and the matrix part is composed of a cured gelatin product. The colloidal crystal layer changes color development according to a heat treatment, but the production process is very complicated. In addition, the colloidal crystal layer has poor resistance and durability.

In addition, as in Patent Literature 2 and 3, since the difference in refractive index between the particle and the matrix component is small, excellent color development cannot be exhibited with a thin film. In addition, the color development does not change according to a heat treatment.

Patent Literature 5 discloses a colloidal crystal layer in which microcapsules containing a hydrocarbon compound are regularly arranged and the matrix part is replaced with a fluoropolymer. In the colloidal crystal layer, since the difference in refractive index between the particle and the matrix component is small, excellent color development cannot be exhibited with a thin film. In addition, the color development does not change according to a heat treatment. In addition, hydrocarbon components eluted from the crushed microcapsules permeate into the non-heated part and thus adversely affect physical properties of coatings.

### CITATION LIST

### Patent Literature

[Patent Literature 1]
PCT International Publication No. WO 2006/129506
[Patent Literature 2]
Japanese Patent Laid-Open No. 2006-028202
[Patent Literature 3]
Published Japanese Translation No. 2005-516083 of the PCT International Publication
[Patent Literature 4]
Japanese Patent Laid-Open No. 2009-210501
[Patent Literature 5]
Japanese Patent Laid-Open No. 2009-293976

### SUMMARY OF INVENTION

### Technical Problem

An objective achieved by the present invention is to provide a laminate which has an excellent structural color even with a thin film having a colloidal crystal layer thickness of 0.5 to 100 μm and has excellent storage stability and resistance, and in which color development of the colloidal crystal layer is irreversibly faded according to a heat treatment, and which can be suitably used as a heat-sensitive recording body, a heat-sensitive recording body formed using the laminate, and a method for forming an image.

### Solution to Problem

The present invention relates to a laminate in which a substrate, a primer layer formed from a resin, and a colloidal crystal layer that develops color due to light interference are arranged in this order, wherein the resin forming the primer layer has a glass transition point in a range of −35 to 100° C., the colloidal crystal layer contains core-shell-type resin fine particles and achromatic black fine particles, and has voids, the core-shell-type resin fine particles contain a shell in a range of 10 to 150 mass % based on a mass of a core, and the shell has a glass transition point in a range of −60 to 40° C., and the colloidal crystal layer has a thickness in a range of 0.5 to 100 μm.

In addition, the present invention relates to the laminate, wherein the core has a glass transition point of 50° C. or higher.

In addition, the present invention relates to the laminate, wherein the colloidal crystal layer contains the achromatic black fine particles in a range of 0.3 to 3 mass % based on the mass of the core-shell-type resin fine particles.

In addition, the present invention relates to the laminate, wherein the resin forming the primer layer has an acid value in a range of 5 to 140 mg KOH/g.

In addition, the present invention relates to the laminate, wherein the core of the core-shell-type resin fine particles contains a structural unit derived from an aromatic ethylenically unsaturated monomer in a range of 70 to 100 mass % based on the mass of the core.

In addition, the present invention relates to the laminate, wherein the shell of the core-shell-type resin fine particles contains, based on the mass of the shell, a structural unit derived from an ethylenically unsaturated monomer (s-1) having an octanol/water partition coefficient in a range of 1 to 2.5 in a range of 70 to 99.5 mass % and a structural unit derived from an ethylenically unsaturated monomer (s-2) having an octanol/water partition coefficient of less than 1 in a range of 0.5 to 15 mass %.

In addition, the present invention relates to the laminate, wherein the core-shell-type resin fine particles contain a structural unit derived from a reactive surfactant.

In addition, the present invention relates to the laminate, which has a resin layer on the colloidal crystal layer.

In addition, the present invention relates to a heat-sensitive recording body formed using the laminate.

In addition, the present invention relates to the heat-sensitive recording body, further including an adhesive layer.

In addition, the present invention relates to a method for forming an image, including heating the heat-sensitive recording body to fade color development of a colloidal crystal layer.

### Advantageous Effects of Invention

According to the present invention, it is possible to provide a laminate which has an excellent structural color even with a thin film having a colloidal crystal layer thickness of 0.5 to 100 μm and has excellent storage stability and resistance, and in which color development of the colloidal crystal layer is irreversibly faded according to a heat treatment, and which can be suitably used as a heat-sensitive recording body, a heat-sensitive recording body formed using the laminate, and a method for forming an image.

### BRIEF DESCRIPTION OF DRAWINGS

FIG. 1 is a diagram schematically showing a laminate according to one embodiment of the present invention.

FIG. 2 is a diagram schematically showing a state in which the laminate according to one embodiment of the present invention is heated, and color of a colloidal crystal layer fades.

### DESCRIPTION OF EMBODIMENTS

### <Laminate>

A laminate of the present invention has a configuration in which a substrate, a primer layer, and a colloidal crystal layer are laminated in this order. The colloidal crystal layer contains core-shell-type resin fine particles and achromatic black fine particles, and has voids, and the resin forming the primer layer has a glass transition point in a range of −35 to 100° C. The core-shell-type resin fine particles contain a shell in a range of 10 to 150 mass % based on the mass of the core, and the shell has a glass transition point in a range of −60 to 40° C. Here, the colloidal crystal layer has a thickness in a range of 0.5 to 100 μm.

With the above configuration, the laminate of the present invention has an excellent structural color even with a thin film having a colloidal crystal layer of 0.5 to 100 μm. In addition, the laminate is excellent in storage stability and various resistances (abrasion resistance, substrate conformability, water resistance, and solvent resistance). In addition, when the laminate is heated using a thermal head, a laser or the like, the colloidal crystal layer undergoes a clear color development change.

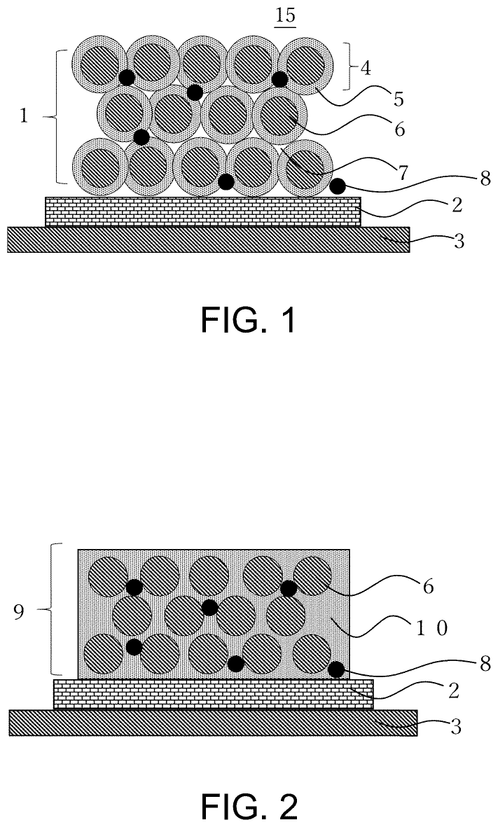

FIG. 1 is a schematic cross-sectional view of an example of a laminate of the present invention. As shown in FIG. 1, a laminate 15 of the present invention has a configuration in which a substrate 3, a primer layer 2, and a colloidal crystal layer 1 are laminated in this order. The colloidal crystal layer 1 contains core-shell-type resin fine particles 4 having a structure of a core 6 and a shell 5 and achromatic black fine particles 8. The core-shell-type resin fine particles 4 have a closely packed structure, and with voids 7 remaining, the shells 5 are fused and bonded to each other between the core-shell-type resin fine particles 4. Since the laminate of the present invention has a large refractive index difference between the core-shell-type resin fine particles 4 and the voids 7, it exhibits a vivid structural color even with a thin film.

On the other hand, when the laminate 15 is heated by applying a certain level or more of thermal energy, the shells 5 of the core-shell-type resin fine particles 4 flow and fill the void parts, and as shown in FIG. 2, a heated colloidal crystal layer 9 is assumed to have a sparsely packed structure. In such a sparsely packed structure, since the difference in refractive index between a particle-like core 6 and a matrix 10 is small, the thin film becomes a translucent layer without exhibiting a structural color, and the color of the layer below the heated colloidal crystal layer 9 (sparsely packed structure) can be visually observed.

Hereinafter, embodiments of the present invention will be described in detail.

### <Primer Layer>

A primer layer in the present invention is provided between a substrate and a colloidal crystal layer, and has a function of inhibiting interfacial separation between the substrate and the colloidal crystal layer. When the primer layer is provided, the adhesion with the colloidal crystal layer is improved, and a laminate having excellent substrate conformability, abrasion resistance, water resistance and the like can be obtained. The primer layer is preferably water-insoluble.

The resin forming the primer layer is not particularly limited, and can be appropriately selected depending on the type of the substrate and colloidal crystal layer. Preferably, it includes at least one resin selected from the group consisting of acrylic resins, urethane resins, polyolefin resins, polyester resins, and composite resins obtained by combining these resins. Among these, in consideration of excellent adhesion to the substrate and the colloidal crystal layer and excellent water resistance, solvent resistance and transparency of the primer layer, it preferably includes at least one selected from the group consisting of acrylic resins and urethane resins, more preferably includes an acrylic resin, and still more preferably includes an acrylic resin containing styrene in a structural unit (hereinafter referred to as a styrene acrylic resin).

An acrylic resin is preferably used because adhesion to the substrate and the colloidal crystal layer and substrate conformability and water resistance of the primer layer are excellent, and substrate conformability, abrasion resistance and water resistance of the laminate become favorable.

These resins may be used alone or two or more thereof may be used in combination.

In order to reduce the influence on the colloidal crystal layer, the resin forming the primer layer preferably has a low content of unreacted components and residual solvents, and an aqueous resin is preferably used. Here, the aqueous resin is a resin that can be dispersed or dissolved in an aqueous medium, and the aqueous medium includes water and a dispersion medium or a solvent that can be mixed with water.

When the resin forming the primer layer is an aqueous resin, the method of producing the aqueous resin is not particularly limited. In order to obtain a resin having a low viscosity, a high solid content and a high molecular weight, an emulsion polymerization method is preferable.

### [Acrylic Resin]

When the resin forming the primer layer is an aqueous acrylic resin, the aqueous acrylic resin can be obtained by emulsion polymerization of ethylenically unsaturated monomers including (meth)acrylic monomer.

### {Ethylenically Unsaturated Monomer}

Examples of ethylenically unsaturated monomers include aromatic ethylenically unsaturated monomers such as styrene, α-methyl styrene, o-methyl styrene, p-methyl styrene, m-methyl styrene, vinylnaphthalene, benzyl (meth)acrylate, phenoxyethyl (meth)acrylate, phenoxydiethylene glycol (meth)acrylate, phenoxytetraethylene glycol (meth)acrylate, phenoxyhexaethylene glycol (meth)acrylate, phenoxyhexaethylene glycol (meth)acrylate, and phenyl (meth)acrylate; linear or branched alkyl group-containing ethylenically unsaturated monomers such as methyl (meth)acrylate, ethyl (meth)acrylate, propyl (meth)acrylate, n-butyl (meth)acrylate, t-butyl (meth)acrylate, pentyl (meth)acrylate, heptyl (meth)acrylate, hexyl (meth)acrylate, 2-ethylhexyl (meth)acrylate, octyl (meth)acrylate, nonyl (meth)acrylate, decyl (meth)acrylate, undecyl (meth)acrylate, lauryl (meth)acrylate, tridecyl (meth)acrylate, tetradecyl (meth)acrylate, decyl (meth)acrylate, hexadecyl (meth)acrylate, heptadecyl (meth)acrylate, stearyl (meth)acrylate, isostearyl (meth)acrylate, and behenyl (meth)acrylate; alicyclic alkyl group-containing ethylenically unsaturated monomers such as cyclohexyl (meth)acrylate, isobornyl (meth)acrylate, and 1-adamantyl (meth)acrylate; fluorinated alkyl group-containing ethylenically unsaturated monomers such as trifluoroethyl (meth)acrylate and heptadecafluorodecyl (meth)acrylate; carboxyl group-containing ethylenically unsaturated monomers such as (anhydrous) maleic acid, fumaric acid, itaconic acid, citraconic acid, or their alkyl or alkenyl monoesters, β-(meth)acryloxyethyl succinate monoester, acrylic acid, methacrylic acid, crotonic acid, and cinnamic acid; sulfo group-containing ethylenically unsaturated monomers such as sodium 2-acrylamide 2-methylpropanesulfonate, methallylsulfonic acid, methallylsulfonic acid, sodium methallylsulfonate, allylsulfonic acid, sodium allylsulfonate, ammonium allylsulfonate, and vinylsulfonic acid; amide group-containing ethylenically unsaturated monomers such as (meth)acrylamide, N-methoxymethyl-(meth)acrylamide, N-ethoxymethyl-(meth)acrylamide, N-propoxymethyl-(meth)acrylamide, N-butoxymethyl-(meth)acrylamide, N-pentoxymethyl-(meth)acrylamide, N,N-di(methoxymethyl)acrylamide, N-ethoxymethyl-N-methoxymethyl methacrylamide, N,N-di(ethoxymethyl)acrylamide, N-ethoxymethyl-N-propoxymethyl methacrylamide, N,N-di(propoxymethyl)acrylamide, N-butoxymethyl-N-(propoxymethyl)methacrylamide, N,N-di(butoxymethyl)acrylamide, N-butoxymethyl-N-(methoxymethyl)methacrylamide, N,N-di(pentoxymethyl)acrylamide, N-methoxymethyl-N-(pentoxymethyl)methacrylamide, N,N-dimethylaminopropyl acrylamide, N,N-diethylaminopropyl acrylamide, N,N-dimethylacrylamide, N,N-diethylacrylamide, and diacetoneacrylamide; hydroxyl group-containing ethylenically unsaturated monomers such as 2-hydroxyethyl (meth)acrylate, 2-hydroxypropyl (meth)acrylate, 4-hydroxybutyl (meth)acrylate, glycerol mono (meth)acrylate, 4-hydroxyvinylbenzene, 1-ethynyl-1-cyclohexanol, and allyl alcohol; polyoxyethylene group-containing ethylenically unsaturated monomers such as methoxy polyethylene glycol (meth)acrylate, and polyethylene glycol (meth)acrylate; for example, dimethylaminoethyl (meth)acrylate, diethylaminoethyl (meth)acrylate, methylethylaminoethyl (meth)acrylate, dimethylaminostyrene, and diethylaminostyrene, and amino group-containing ethylenically unsaturated monomers such as dimethylaminoethyl (meth)acrylate, diethylaminoethyl (meth)acrylate, and methylethylaminoethyl (meth)acrylate; epoxy group-containing ethylenically unsaturated monomers such as glycidyl (meth)acrylate, and 3,4-epoxycyclohexyl (meth)acrylate; ketone group-containing ethylenically unsaturated monomers such as diacetone (meth)acrylamide, and acetoacetoxy (meth)acrylate; ethylenically unsaturated monomers containing two or more ethylenically unsaturated groups such as allyl (meth)acrylate, 1-methylallyl (meth)acrylate, 2-methylallyl (meth)acrylate, 1-butenyl (meth)acrylate, 2-butenyl (meth)acrylate, 3-butenyl (meth)acrylate, 1,3-methyl-3-butenyl (meth)acrylate, 2-chlorallyl (meth)acrylate, 3-chlorallyl (meth)acrylate, o-allyl phenyl (meth)acrylate, 2-(allyloxy)ethyl (meth)acrylate, allyllactyl (meth)acrylate, citronellyl (meth)acrylate, geranyl (meth)acrylate, rosinyl (meth)acrylate, cinnamyl (meth)acrylate, diallyl maleate, diallyl itaconate, vinyl (meth)acrylate, vinyl crotonate, vinyl oleate, vinyl linolenate, 2-(2′-vinyloxyethoxy)ethyl (meth)acrylate, ethylene glycol di(meth)acrylate, triethylene glycol (meth)acrylate, tetraethylene glycol (meth)acrylate, trimethylolpropane tri(meth)acrylate, pentaerythritol tri(meth)acrylate, 1,1,1-trishydroxymethylethane diacrylate, 1,1,1-trishydroxymethylethane triacrylate, 1,1,1-trishydroxymethylpropane triacrylate, divinylbenzene, divinyl adipate, diallyl isophthalate, diallyl phthalate, and diallyl maleate; alkoxysilyl group-containing ethylenically unsaturated monomers such as y-methacryloxypropyltrimethoxysilane, 3-methacryloxypropyltriethoxysilane, 3-methacryloxypropyltributoxysilane, 3-methacryloxypropylmethyldimethoxysilane, 3-methacryloxypropylmethyldiethoxysilane, 3-acryloxypropyltrimethoxysilane, 3-acryloxypropyltriethoxysilane, 3-acryloxypropylmethyldimethoxysilane, 3-methacryloxymethyltrimethoxysilane, 3-acryloxymethyltrimethoxysilane, vinyltrimethoxysilane, vinyltriethoxysilane, vinyltributoxysilane, and vinylmethyldimethoxysilane; and methylol group-containing ethylenically unsaturated monomers such as N-methylol (meth)acrylamide, N,N-dimethylol (meth)acrylamide, and alkyl etherified N-methylol(meth)acrylamide.

These monomers may be used alone or two or more thereof may be used in combination.

The ethylenically unsaturated monomer may have a reactive group in order to cross-link the primer layer and the core-shell-type resin fine particles that form the colloidal crystal layer.

Examples of reactive groups include epoxy groups, carboxyl groups, hydroxyl groups, ketone groups, and hydrazide groups, and ketone groups are more preferable. Particularly, when the reactive group is a ketone group and the cross-linking agent to be described below is a hydrazide cross-linking agent, a ketone-hydrazide cross-link can be formed. In addition, it is thought that, when the aqueous acrylic resin includes resin fine particles that can be dispersed in an aqueous medium, if an ethylenically unsaturated monomer having a ketone group with high hydrophilicity is used in a copolymer composition, the ketone group is introduced to the outside of the resin fine particles, that is, the vicinity of the interface with the aqueous medium, and can efficiently form cross-links with the hydrazide cross-linking agent.

When the aqueous acrylic resin contains a ketone group, the content of the ketone group based on the mass of the aqueous acrylic resin is preferably in a range of 0.05 to 0.3 mmol/g. When the resin in a range of 0.05 to 0.3 mmol/g is introduced, since cross-links are formed while fusion of the aqueous acrylic resin is not inhibited, the primer layer and the colloidal crystal layer are more firmly bonded. Accordingly, the obtained laminate is excellent in various resistances (abrasion resistance, water resistance, and solvent resistance).

### {Radical Polymerization Initiator}

Known oil-soluble polymerization initiators and water-soluble polymerization initiators can be used as the radical polymerization initiator produced in the aqueous acrylic resin, and these may be used alone or two or more thereof may be used in combination.

The oil-soluble polymerization initiator is not particularly limited, and examples thereof include organic peroxides such as benzoyl peroxide, tert-butyl peroxybenzoate, tert-butyl hydroperoxide, tert-butyl peroxy(2-ethylhexanoate), tert-butylperoxy-3,5,5-trimethylhexanoate, and di-tert-butylperoxide; and azobis compounds such as 2,2′-azobisisobutyronitrile, 2,2′-azobis-2,4-dimethylvaleronitrile, 2,2′-azobis(4-methoxy-2,4-dimethylvaleronitrile), and 1,1′-azobis-cyclohexane-1-carbonitrile.

In emulsion polymerization, it is preferable to use a water-soluble polymerization initiator, and as the water-soluble polymerization initiator, for example, conventionally known initiators such as ammonium persulfate (APS), potassium persulfate (KPS), hydrogen peroxide, and 2,2′-azobis(2-methylpropionamidine) dihydrochloride can be suitably used. {Surfactant}

Surfactants are generally used in the production of aqueous acrylic resins, and when surfactants are used, it is possible to improve the stability and monodispersity of resin fine particles. Examples of surfactants include anionic or nonionic surfactants, and anionic surfactants are preferable. These may be used alone or two or more thereof may be used in combination.

Examples of surfactants include anionic reactive surfactants, anionic non-reactive surfactants, nonionic reactive surfactants, and nonionic non-reactive surfactants. Here, the reactive surfactant is a surfactant that is polymerizable with the above ethylenically unsaturated monomers. More specifically, it is a surfactant having a reactive group that can undergo a polymerization reaction with an ethylenically unsaturated bond. Examples of reactive groups include alkenyl groups such as a vinyl group, allyl group, and 1-propenyl group, and a (meth)acryloyl group.

When the reactive surfactant is used, the content of free surfactant components contained in the aqueous acrylic resin is reduced, and the adverse effect of colloidal crystals on particle arrangement is reduced, and thus it is possible to obtain a laminate that is a thin film and exhibits more vivid structural color development.

### {Other Components}

In the production of aqueous acrylic resins, as necessary, it is possible to use a reducing agent, a buffering agent, and a chain transfer agent, and a neutralizing agent.

### [Urethane Resin]

When the resin forming the primer layer is an aqueous urethane resin, the aqueous urethane resin is not particularly limited. The aqueous urethane resin can be obtained by, for example, a method of dispersing a urethane resin obtained by a polyaddition reaction of an arbitrary polyol and a polyisocyanate in a non-aqueous system in water using a surfactant or a method of self-emulsification by introducing a hydrophilic group such as a carboxyl group into a urethane resin.

The aqueous urethane resin may have a terminal to which a functional group may be introduced by reacting a diamine or a dihydrazide compound with a terminal isocyanate group, and may be polymerized by chain extension. In addition, the aqueous urethane resin may be combined with a different resin by grafting an acrylic resin framework or an olefin resin framework via a reactive group.

Examples of polyols constituting urethane resins include a polyether polyol, polyester polyol, polycarbonate polyol, polyolefin polyol, and castor oil polyol.

Examples of polyether polyols include polyethylene glycol, polypropylene glycol, poly(ethylene/propylene) glycol, and polytetramethylene glycol.

Examples of polyester polyols include reaction products of difunctional polyols or trifunctional polyols with dibasic acids. Examples of difunctional polyols include ethylene glycol, propylene glycol, dipropylene glycol, diethylene glycol, triethylene glycol, butylene glycol, 1,6-hexanediol, 3-methyl-1,5-pentanediol, 3,3′-dimethylolheptane, polyoxyethylene glycol, polyoxypropylene glycol, 1,3-butanediol, 1,4-butanediol, neopentyl glycol, octanediol, butyl ethyl pentanediol, 2-ethyl-1,3-hexanediol, cyclohexanediol, and bisphenol A. Examples of trifunctional polyols include glycerin, trimethylolpropane, and pentaerythritol. Examples of dibasic acids include terephthalic acid, adipic acid, azelaic acid, sebacic acid, dimer acid, hydrogenated dimer acid, phthalic anhydride, isophthalic acid, and trimellitic acid.

Examples of polycarbonate polyols include reaction products of the above difunctional polyol with dialkyl carbonates, alkylene carbonates, and diaryl carbonates.

Examples of polyolefin polyols include a hydroxyl group-containing polybutadiene, acid group-containing hydrogenated polybutadiene, hydroxyl group-containing polyisoprene, hydroxyl group-containing hydrogenated polyisoprene, hydroxyl group-containing chlorinated polypropylene, and hydroxyl group-containing chlorinated polyethylene.

Examples of polyisocyanates constituting urethane resins include aromatic polyisocyanates such as 2,4-tolylene diisocyanate, 2,6-tolylene diisocyanate, m-phenylene diisocyanate, p-phenylene diisocyanate, 4,4′-diphenylmethane diisocyanate, xylylene diisocyanate, lysine diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalenediisocyanate, and 1,5-tetrahydronaphthalene diisocyanate; aliphatic polyisocyanates such as tetramethylene diisocyanate, hexamethylene diisocyanate, and trimethylhexamethylene diisocyanate; and alicyclic polyisocyanates such as isophorone diisocyanate, 1,4-cyclohexylene diisocyanate, and 4,4′-dicyclohexylmethane diisocyanate.

In synthesis of urethane resins, low-molecular-weight diols may be used together in order to adjust the concentration of urethane bonds and introduce various functional groups. As low-molecular-weight diol, a diol having a molecular weight of 500 or less is preferable, and examples thereof include ethylene glycol, 1,2-propanediol, 1,3-propanediol, 1,3-butanediol, 1,4-butanediol, neopentyl glycol, pentanediol, hexanediol, octanediol, 2-butyl-2-ethyl-1,3-propanediol, 1,4-butylenediol, dipropylene glycol, glycerin, trimethylolpropane, trimethylolethane, 1,2,6-butanetriol, pentaerythritol, sorbitol, N, N-bis(2-hydroxypropyl)aniline, dimethylol alkanoic acids such as dimethylolacetic acid, dimethylolpropionic acid, dimethylolbutanoic acid, 2,2-dimethylolbutyric acid, and 2,2-dimethylolpentanoic acid, dihydroxysuccinic acid, dihydroxypropionic acid, and dihydroxybenzoic acid.

Examples of compounds that can be used for terminal modification and chain extension reactions include diamines such as hydrazine, ethylene diamine, propylene diamine, hexamethylene diamine, nonamethylene diamine, xylylene diamine, isophorone diamine, piperazine and its derivative, phenylene diamine, tolylene diamine, xylene diamine, and N-(β-aminoethypethanolamine, and dihydrazides such as adipic acid dihydrazide and isophthalic acid dihydrazide.

Examples of commercial products of aqueous urethane resins include SUPERFLEX series (SF-170, SF-210, etc., commercially available from DKS Co., Ltd.), UCOAT, PERMARIN series (UX-310, UX-3945, etc., commercially available from Sanyo Chemical Industries, Ltd.), Urearno series (W-600, W-321, etc., commercially available from Arakawa Chemical Industries, Ltd.), Adeka Bontighter series (HUX-420A, HUX-386, etc., commercially available from ADEKA), UW series (UW-5002, UW-5020, etc., commercially available from Ube Industries, Ltd.), and Acrit series (WBR2000U, WBR2101, WEM-200U, etc., commercially available from Taisei Fine Chemical Co., Ltd.).

### [Polyolefin Resin]

When the resin forming the primer layer is an aqueous polyolefin resin, as the aqueous polyolefin resin, for example, an acid-modified polyolefin obtained by modifying a base resin such as an ethylene-propylene copolymer, a propylene-1-butene copolymer, and an ethylene-propylene-1-butene copolymer with maleic acid or the like can be used. The polyolefin resin may be combined with a different resin by grafting an acrylic resin framework.

An aqueous dispersion of the aqueous polyolefin resin can be obtained by a method of performing dispersion in water using a surfactant or a method of self-emulsification by introducing a hydrophilic group into a polyolefin resin.

Examples of commercial products of aqueous polyolefin resins include SUPERCHLON series and AUROREN series (E-480T, AE-301, etc., commercially available from Nippon Paper Industries Co., Ltd.), Arrowbase series (SB-1230N, SB-1200, etc., commercially available from Unitika Ltd.), and APTOLOK series (BW-5550, etc., commercially available from Mitsubishi Chemical Corporation).

### [Polyester Resin]

When the resin forming the primer layer is an aqueous polyester resin, the aqueous polyester resin is not particularly limited. The aqueous polyester resin can be obtained by reacting a difunctional or trifunctional polyol with a dibasic acid. For the difunctional or trifunctional polyols and dibasic acids, the description in the section of the above [Urethane resin] can be used.

An aqueous dispersion of the aqueous polyester resin can be obtained by a method of performing dispersion in water using a surfactant or a method of self-emulsification by introducing a hydrophilic group into a polyester resin.

Examples of commercial products of aqueous polyester resins include Plas Coat series (Z-730, Z-760, etc., commercially available from Goo Chemical Co., Ltd.).

It is important that the resin forming the primer layer in the present invention have a glass transition point (Tg) in a range of −35 to 100° C. When the glass transition point is within the above range, it is possible to prevent a primer component from excessively entering voids in the colloidal crystal layer and it is possible to maintain a favorable structural color for a long time. In addition, the wettability with the substrate and the surface of core-shell-type resin fine particles is good, and the adhesion is excellent. In addition, fusion between the primer layer and the shell of core-shell-type resin fine particles is promoted, and the strength of the bonded part is excellent. Accordingly, the obtained laminate is excellent in the color development property, storage stability, and various resistances (abrasion resistance and substrate conformability).

The resin preferably has a glass transition point in a range of −30 to 70° C. and may have a plurality of glass transition points.

The glass transition point in this specification can be obtained using a differential scanning calorimeter (DSC).

The resin forming the primer layer preferably has a carboxyl group. The acid value of the resin is preferably in a range of 5 to 140 mg KOH/g and more preferably in a range of 5 to 70 mg KOH/g. When the acid value is within the above range, the adhesion between the primer layer and the substrate is improved. In addition, the adhesion between the colloidal crystal layer and the primer layer is improved. In addition, swelling or eluting of the primer layer due to water or the like, and breaking of colloidal crystal regular arrangement are inhibited. Accordingly, the obtained laminate is in excellent in the color development property and resistance (substrate conformability and water resistance).

### [Primer Composition]

A method of forming a primer layer is not particularly limited, and for example, the layer can be formed by applying a primer composition containing an aqueous resin that forms a primer layer and water onto a substrate, and drying it as necessary.

The thickness of the primer layer is not particularly limited, and is preferably 0.5 to 50 lam, more preferably 2 to 20 μm, and still more preferably 2 to 10 μm in consideration of function expression and productivity of the primer layer. When the thickness of the primer layer is 0.5 μm or more, the adhesion between the primer layer and the substrate layer and between the primer layer and the colloidal crystal layer is improved, and substrate conformability, abrasion resistance and water resistance of the laminate are excellent.

The thickness of each layer in this specification can be measured by observing the cross section of the laminate using a scanning electron microscope.

In order to improve the coatability, the color development property of the laminate, and sensitivity to the color change and improve the film resistance, the primer composition may contain various additives such as a hydrophilic solvent, achromatic black fine particles, a photothermal conversion agent, and a cross-linking agent as long as it does not adversely affect the physical properties of the laminate.

### {Hydrophilic Solvent}

Examples of hydrophilic solvents include monohydric alcohol solvents such as ethanol, n-propanol, and isopropanol; glycol solvents such as ethylene glycol, 1,3-propanediol, and propylene glycol; glycol ether solvents such as ethylene glycol monomethyl ether, diethylene glycol monomethyl ether, diethylene glycol monobutyl ether, and triethylene glycol monoethyl ether; lactam solvents such as N-methyl-2-pyrrolidone, N-hydroxyethyl-2-pyrrolidone, and c-caprolactam; and amide solvents such as formamide and N-methylformamide.

### {Achromatic Black Fine Particles}

Achromatic black fine particles have a function of absorbing scattered light in the laminate and making color development clearer. As the achromatic black fine particles, fine particles colored with a black dye, carbon black, graphite or the like can be used. Carbon black is preferable because it has little influence on the shape of the reflection spectrum in the visible region and has excellent durability such as weather resistance.

In addition, the achromatic black fine particles have a function of absorbing a laser beam such as infrared laser and accelerating heating of core-shell-type resin fine particles in the adjacent colloidal crystal layer. Thereby, the shells are efficiently fluidized and fill voids, and the color changes with favorable sensitivity.

### {Photothermal Conversion Agent}

When a laser beam is emitted to the laminate, the photothermal conversion agent (provided that achromatic black fine particles are excluded) has a function of accelerating heating of core-shell-type resin fine particles in the adjacent colloidal crystal layer. Examples of photothermal conversion agents include cyanine dyes, croconium dyes, polymethine dyes, azulenium dyes, squarium dyes, thiopyrylium dyes, naphthoquinone dyes, anthraquinone dyes, phthalocyanine dyes, naphthalocyanine dyes, azo dyes, thioamide dyes, dithiol dyes, and indoaniline dyes.

### {Cross-Linking Agent}

The cross-linking agent that the primer composition may contain is not particularly limited, and examples thereof include a hydrazide compound (polyhydrazide) having two or more hydrazide groups that react with an active carbonyl group to form a ketone-hydrazide cross-link, an isocyanate compound that reacts with a hydroxyl group and an amino group to form a urethane bond and a urea bond, an epoxy compound that reacts with a carboxyl group, an amino group or the like, and a carbodiimide compound, and the cross-linking agent can be appropriately selected.

For example, when the resin contained in the primer composition has a carboxyl group, cross-links can be formed via an epoxy cross-linking agent or a polycarbodiimide cross-linking agent. For example, when the resin contained in the primer composition has a hydroxyl group, cross-links can be formed via a polyisocyanate cross-linking agent. For example, when the resin contained in the primer composition has a ketone group, cross-links can be formed via a hydrazide cross-linking agent.

As the cross-linking agent, as described above, it is preferable to use a hydrazide cross-linking agent in order to form a ketone-hydrazide cross-link. Examples of hydrazide cross-linking agents include adipic acid dihydrazide and water soluble resins in which multifunctional hydrazide groups are modified.

### <Colloidal Crystal Layer>

The laminate of the present invention has a colloidal crystal layer that develops color due to light interference. Since the colloidal crystal layer has a regularly arranged structure, it exhibits a structural color derived from Bragg reflection and has a color development function. In addition, the colloidal crystal layer contains core-shell-type resin fine particles and achromatic black fine particles, and has voids.

When the core-shell-type resin fine particles have a regular arrangement structure, since the shells of adjacent core-shell-type resin fine particles and the shell of the core-shell-type resin fine particles and the layer in contact with the shell are easily bonded, favorable coating resistance is exhibited. The achromatic black fine particles have a function of absorbing scattered light in the colloidal crystal layer and making color development clearer. In addition, when the colloidal crystal layer has voids, since the difference in refractive index between the particles and the voids becomes large, the laminate exhibits an excellent structural color.

In addition, the achromatic black fine particles have a function of absorbing a laser beam, heating, and promoting fusion of core-shell-type resin fine particles in the adjacent colloidal crystal layer. Thereby, the shells are efficiently fluidized and fill voids, and the color changes with favorable sensitivity.

### [Core-Shell-Type Resin Fine Particles]

The core-shell-type resin fine particles have a core and a shell made of a water-insoluble polymer, and include a structure of a core (inner layer) and a shell (outer layer) that are incompatible with each other. The core maintains a spherical shape, and the shell has fluidity and functions as a bonding site. The core-shell-type resin fine particles in this specification may have a multilayer structure inside each of the core and the shell, and may have a gradient in the composition. A composition containing core-shell-type resin fine particles is applied to a substrate or the like, and as a medium such as water volatilizes, the particles advectively accumulate in a regular arrangement, and the shells of the particles are fused together to such an extent that voids are not filled, and a colloidal crystal layer is formed.

The shells of the core-shell-type resin fine particles bind the achromatic black fine particles contained in the colloidal crystal layer and also has a function of preventing achromatic black fine particles from falling off. Therefore, the laminate having core-shell-type resin fine particles, achromatic black fine particles, and voids exhibits a vivid structural color and has excellent various film resistances (abrasion resistance, substrate conformability, water resistance, and solvent resistance).

On the other hand, when a certain level or more of thermal energy is applied to the laminate, the shells flow and fill voids in the heated part. Accordingly, the structural color of the colloidal crystal layer fades and thus the color development of the laminate changes greatly. In addition, cracks do not occur in the faded part because a film is formed with the fluidized shells and flexibility is excellent. Accordingly, like the unheated laminate, the heated laminate has excellent film resistances (abrasion resistance, substrate conformability, water resistance, and solvent resistance).

It is important that the core-shell-type resin fine particles contain the shells in a range of 10 to 150 mass % based on the mass of the core. When the content of the shell is 10 mass % or more, since voids are sufficiently filled during heating, a laminate exhibiting an excellent color development change can be obtained. In addition, the bonding between the core-shell-type resin fine particles and between the core-shell-type resin fine particles and the primer layer also becomes stronger, and substrate conformability is also better.

If the content of the shell is 150 mass % or less, when a colloidal crystal layer composition is dried and when a laminate is stored for a long time, excessive fusion of shells to fill voids, and deterioration of the color development property are minimized. Accordingly, the obtained laminate has an excellent color development property and storage stability and exhibits a clear color development change according to a heat treatment. The content of the shell is preferably in a range of 30 to 100 mass %.

It is important that the shells of the core-shell-type resin fine particles have a glass transition point in a range of −60 to 40° C. When the glass transition point is within the above range, void parts in the colloidal crystal layer are prevented from being excessively filled by fusion of the shells of the core-shell-type resin fine particles during heating and drying. In addition, fusion of the shells is promoted between the core-shell-type resin fine particles between the core-shell-type resin fine particles and the primer layer, and between the core-shell-type resin fine particles and the resin layer to be described below, and the strength of the bonded part is sufficiently exhibited. In addition, during heating, the shells fluidize with favorable sensitivity and can fill void parts. Accordingly, the obtained laminate has an excellent color development property and storage stability and exhibits a clear color development change according to a heat treatment. In addition, various film resistances (abrasion resistance, substrate conformability, water resistance, and solvent resistance) in the heated part and the non-heated part are excellent.

The core of the core-shell-type resin fine particles preferably has a glass transition point of 50° C. or higher, and more preferably has a glass transition point in a range of 60° C. to 150° C. When the glass transition point is 50° C. or higher, the shape of the core is prevented from being deformed due to the influence of heat and force from the outside. Accordingly, even if the laminate is stored for a long time, it is possible to maintain excellent color development.

The shell and core may have a plurality of glass transition points.

The core-shell-type resin fine particles in the present invention are not particularly limited, and are preferably an ethylenically unsaturated monomer polymer, more preferably an acrylic resin, and still more preferably a styrene acrylic resin.

The method of producing core-shell-type resin fine particles is not particularly limited, and examples thereof include a method of polymerizing ethylenically unsaturated monomers in an aqueous medium such as emulsion polymerization and a phase inversion emulsification method in which phase inversion to an aqueous phase occurs while removing a solvent after polymerization is performed in a non-aqueous system, but it is preferable to use emulsion polymerization because it is possible to achieve a high molecular weight, a low viscosity, and a high solid content concentration. In addition, in the emulsion polymerization, either two-stage polymerization in which a monomer composition is changed between the first stage and the second stage and added dropwise or multi-stage polymerization in which a monomer composition is changed in multiple stages of three or more stages and added dropwise may be used.

The core-shell-type resin fine particles can be prepared according to the above two-stage polymerization, specifically, by the following procedures.

(1) First, an aqueous medium and a surfactant are put into a reaction tank, and the temperature is raised. Then, a radical polymerization initiator is added while a first-stage ethylenically unsaturated monomer emulsion that forms the core is added dropwise under a nitrogen atmosphere. After the reaction starts, the particles gradually grow according to the amount of added dropwise to form core particles.
(2) Next, when first-stage dropwise addition is completed and heat generation is reduced, dropwise addition of a second-stage ethylenically unsaturated monomer emulsion that forms the shell starts. In this case, an additional initiator may be added. The second-stage ethylenically unsaturated monomers added dropwise are temporarily distributed to the core particles, but as polymerization progresses, the monomers are deposited as a polymer on the outer layer of the core particles to form a shell layer.

### {Ethylenically Unsaturated Monomer}

Examples of ethylenically unsaturated monomers that form core-shell-type resin fine particles include ethylenically unsaturated monomers (bc) that form the core and ethylenically unsaturated monomers (bs) that form the shell, and in both cases, the description in the section of <Ethylenically unsaturated monomer> in the above <Primer layer> can be used.

The core of the core-shell-type resin fine particles preferably contains a structural unit derived from an aromatic ethylenically unsaturated monomer in a range of 70 to 100 mass % based on the mass of the core. When the structural unit derived from an aromatic ethylenically unsaturated monomer is included in the above range, the refractive index of the core increases, the difference in refractive index between the particle part and the void part in the colloidal crystal layer increases, and the color development property of the laminate is further improved. Accordingly, the contrast of color development change between the non-heated part and the heated part becomes larger, and a laminate having a better color development property and a clear color change during heating can be obtained. In addition, since the contrast between the core and the shell becomes clear, and the shells can be sufficiently fused, the abrasion resistance of the laminate is improved.

Examples of aromatic ethylenically unsaturated monomers include styrene, α-methyl styrene, o-methyl styrene, p-methyl styrene, m-methyl styrene, vinylnaphthalene, benzyl (meth)acrylate, phenoxyethyl (meth)acrylate, phenoxydiethylene glycol (meth)acrylate, phenoxytetraethylene glycol (meth)acrylate, phenoxyhexaethylene glycol (meth)acrylate, and phenoxyhexaethylene glycol (meth)acrylate.

In addition, the shell of core-shell-type resin fine particles preferably contains, based on the mass of the shell, 70 to 99.5 mass % of a structural unit derived from an ethylenically unsaturated monomer (s-1) having an octanol/water partition coefficient (hereinafter referred to as LogKow) in a range of 1 to 2.5 and a structural unit derived from an ethylenically unsaturated monomer (s-2) having a LogKow of less than 1 in a range of 0.5 to 15 mass %.

When the content of structural units derived from the ethylenically unsaturated monomers (s-1) and (s-2) is within the above range, the polymer generated from the second-stage component added dropwise is not compatible with the core including the structural unit derived from an aromatic ethylenically unsaturated monomer, and the polymer is generated at the interface between the core particle and the aqueous phase, and thus particles with a clearer contrast between the core and the shell can be formed. Accordingly, not only is a binding force between particles improved by fusion of the shells, but also the shells are prevented from becoming excessively hydrophilic, and respective coating resistances (abrasion resistance, substrate conformability, and water resistance) of the laminate become better. In addition, since it has excellent dispersion stability when mixed with achromatic black fine particles, the coatability on the substrate is more stable, a coating without unevennesses or irregularities is obtained, and the color development property of the laminate is further improved.

The octanol/water partition coefficient (LogKow) is represented by the following Formula 1 and is used as an index that indicates whether a certain compound A is likely to be distributed into an aqueous phase or an oil phase (octanol). In the relationship between the aqueous dispersion of resin fine particles and ethylenically unsaturated monomers added dropwise thereto, a larger value of the octanol/water partition coefficient of the ethylenically unsaturated monomer indicates that the ethylenically unsaturated monomers are easily distributed inside the particles, and a smaller value indicates that the monomers are easily distributed in the aqueous phase. The octanol/water partition coefficient of each ethylenically unsaturated monomer is a value calculated using a YMB method (physical property estimation function) of Hansen Solubility Parameter Software HSPiP at 25° C.

octanol/water partition coefficient=Log(concentration of compound A in octanol phase/concentration of compound A in aqueous phase) Formula 1:

Examples of ethylenically unsaturated monomers (s-1) having an octanol/water partition coefficient in a range of 1 to 2.5 include methyl methacrylate (1.13), ethyl acrylate (1.08), ethyl methacrylate (1.63), propyl acrylate (1.60), propyl methacrylate (2.16), n-butyl acrylate (2.23), t-butyl acrylate (1.99), trifluoroethyl (acrylate (1.41), trifluoroethyl methacrylate (1.96), and ethylene glycol dimethacrylate (2.07).

When the octanol/water partition coefficient is less than 1, the ethylenically unsaturated monomers have favorable solubility in water. Examples of ethylenically unsaturated monomers (s-2) having an octanol/water partition coefficient of less than 1 include methyl acrylate (0.59), methoxy ethyl acrylate (0.24), methoxy ethyl methacrylate (0.81), hydroxy ethyl acrylate (−0.22), hydroxyethyl methacrylate (0.33), 4-hydroxybutyl acrylate (0.90), acrylic acid (0.14), methacrylic acid (0.67), acrylamide (−0.53), methacrylamide (0), isopropyl acrylamide (0.96), diacetone acrylamide (0.82), 2-acetoacetoxyethyl methacrylate (0.59), and glycidyl methacrylate (0.59).

Here, the numbers in parentheses in the monomers (s-1) and (s-2) indicate values of the octanol/water partition coefficient of respective monomers.

In addition, the ethylenically unsaturated monomers used to form core-shell-type resin fine particles may have a reactive group in order to form cross-links inside the colloidal crystal layer and between the colloidal crystal layer and the layer in contact with the colloidal crystal layer. When cross-links are formed inside the colloidal crystal layer and between the colloidal crystal layer and the layer in contact with the colloidal crystal layer, various film resistances (abrasion resistance and solvent resistance) of the laminate are improved.

Cross-links inside the colloidal crystal layer and between the colloidal crystal and the layer in contact with the colloidal crystal layer can be introduced by a method of reacting reactive groups of core-shell-type resin fine particles with each other, a method of reacting reactive groups of core-shell-type resin fine particles with reactive groups of the primer layer and/or resin layer to be described below, a method of cross-linking reactive groups of core-shell-type resin fine particles via a multifunctional cross-linking agent, or a method of cross-linking reactive groups of core-shell-type resin fine particles with reactive groups of the primer layer and/or resin layer to be described below.

For the reactive group, the description in the section of <Ethylenically unsaturated monomer> in the above <Primer layer> can be used.

When the core-shell-type resin fine particles have a ketone group, the content of the ketone group based on the mass of the core-shell-type resin fine particles is preferably in a range of 0.05 to 0.3 mmol/g. When the content is in a range of 0.05 to 0.3 mmol/g, since cross-links are formed while fusion of the shells is not inhibited, the bonding between particles and between layers becomes more firm, and the primer layer and the colloidal crystal layer are more firmly bonded. Accordingly, the obtained laminate is excellent in various film resistances (abrasion resistance and solvent resistance).

When the core-shell-type resin fine particles have a reactive group, the reactive group is preferably introduced into the shell. It is preferable to introduce the reactive group into the shell because a synergistic effect of thermal fusion due to entanglement of polymer chains and formation of cross-links is exhibited.

### {Radical Polymerization Initiator}

A known oil-soluble polymerization initiator or water-soluble polymerization initiator can be used as a radical polymerization initiator used for producing core-shell-type resin fine particles, and the description in the section of <Ethylenically unsaturated monomer> in the above <Primer layer> can be used.

### {Surfactant}

Surfactants are generally used in the production of core-shell-type resin fine particles, and when surfactants are used, it is possible to improve the stability and monodispersity of core-shell-type resin fine particles. Examples of surfactants include anionic or nonionic surfactants, and anionic surfactants are preferable. For these surfactants, the description in the section of <Surfactant> in the above <Primer layer> can be used. A reactive low-molecular-weight surfactant is preferable in consideration of the influence of the residual surfactant after synthesis on particle arrangement and film resistance. The residual surfactant is reduced by using a reactive surfactant, and the obtained laminate has an excellent color development property and water resistance. The core-shell-type resin fine particles in the present invention preferably contain a structural unit derived from a reactive surfactant.

### {Other Components}

In the production of core-shell-type resin fine particles, as necessary, it is possible to use a reducing agent, a buffering agent, a chain transfer agent, and a neutralizing agent.

### {Properties of Core-Shell-Type Resin Fine Particles}

The average particle size of core-shell-type resin fine particles in this specification is preferably in a range of 180 to 330 nm. When the average particle size is 180 nm or more, the color development of colloidal crystals in a visible light region becomes clear. When the average particle size is 330 nm or less, the color development of colloidal crystals in a visible light region becomes excellent, scattering by the particles is minimized, and the color development property is further improved.

The average particle size in this specification can be measured by a dynamic light scattering method (measurement device, Nanotrac UPA commercially available from MicrotracBel Corp.), and the peak of the obtained volume particle size distribution data (histogram) is used as an average particle size.

The coefficient of variation (Cv value) of the average particle size in the core-shell-type resin fine particles is preferably 30% or less. The coefficient of variation is a number indicating the uniformity of particle sizes, and can be calculated by the following formula.

coefficient of variation Cv value (%)=standard deviation of particle sizes/average particle size×100 Formula:

[in the formula, the units of the standard deviation and the average particle size are the same]

When fine particles having a high monodispersity with a coefficient of variation of 30% or less are arranged, the regularity of particle arrangement is improved, and a more vivid and clear structural color can be exhibited.

### [Achromatic Black Fine Particles]

The achromatic black fine particles have a function of absorbing scattered light in the colloidal crystal layer and making color development clearer. In addition, the achromatic black fine particles have a function of absorbing a laser beam and accelerating heating of adjacent core-shell-type resin fine particles. Accordingly, fusion of the core-shell-type resin fine particles is promoted and voids are filled more quickly, and thus color development changes clearly and with favorable sensitivity.

For the achromatic black fine particles, the description in the section of <Achromatic black fine particles> in the above <Primer layer> can be used. Carbon black is preferable because it has little influence on the shape of the reflection spectrum in the visible region and has excellent durability such as weather resistance. For carbon black, either a dispersion type in which carbon black is dispersed in water using a dispersant or a self-dispersion type may be used, but a self-dispersion type carbon black is preferable because the dispersant does not influence a fine particle arrangement.

The average particle size of the achromatic black fine particles is preferably in a range of 30 to 300 nm and more preferably 30 to 150 nm. In addition, the content of the achromatic black fine particles based on the mass of the core-shell-type resin fine particles is preferably in a range of 0.3 to 3 mass %. When the average particle size and content of the achromatic black fine particles are within the above ranges, the regular arrangement of the core-shell-type resin fine particles is not adversely affected and extra scattered light in the colloidal crystals is appropriately absorbed. In addition, it is possible to prevent excessive achromatic black fine particles from falling off of the colloidal crystal layer. Accordingly, the obtained laminate has an excellent color development property, a clear color development change according to a heat treatment, and excellent various film resistances (water resistance and solvent resistance).

### [Voids]

For the presence of voids in the colloidal crystal layer, when voids with a most frequent pore diameter of 10 to 200 nm are detected by a nitrogen adsorption method, it is determined that voids are present. The BJH method is adopted from the adsorption side of the nitrogen adsorption isotherm obtained by the nitrogen adsorption method, and the peak top is used as the most frequent pore diameter. For parameters of the BJH method, the standard t curve is plotted with Harkins-Jura, and a volume frequency distribution. BELSORP-maxll (device name, commercially available from MicrotracBel Corp.) is used for measurement. Here, the porosity of the colloidal crystal layer is preferably 10 to 40%. The porosity of the colloidal crystal layer can be directly measured by a mercury intrusion method or a gas adsorption method, or can be obtained from the true density ratio of respective layers.

### [Colloidal Crystal Layer Composition]

A method of forming a colloidal crystal layer is not particularly limited, and for example, the layer can be formed by applying a colloidal crystal layer composition containing core-shell-type resin fine particles, achromatic black fine particles and water onto a primer layer of the substrate that has the primer layer. The thickness of the colloidal crystal layer is 0.5 to 100 μm, and more preferably 3 to 20 μm. When the thickness of the colloidal crystal layer is within the above range, it is possible to obtain a laminate having an excellent color development property and a clear change in color during heating.

In order to improve the coatability and coating resistance, the colloidal crystal layer composition may contain a hydrophilic solvent, a cross-linking agent and the like as long as it does not adversely affect the particle arrangement and physical properties of the laminate.

### {Hydrophilic Solvent}

For the hydrophilic solvent, the description in the section of <Hydrophilic solvent> in the above <Primer layer> can be used.

### {Cross-Linking Agent}

The cross-linking agent that the colloidal crystal layer composition may contain is not particularly limited, and the description in the section of <Cross-linking agent> in the above <Primer layer> can be used.

As the cross-linking agent, it is preferable to use a hydrazide cross-linking agent in order to form a ketone-hydrazide cross-link. Examples of hydrazide cross-linking agents include adipic acid dihydrazide and water soluble resins in which multifunctional hydrazide groups are modified.

### <Resin Layer>

The laminate of the present invention may further have a resin layer on the colloidal crystal layer in order to protect the colloidal crystal layer and improve various film resistances (abrasion resistance, water resistance, and solvent resistance). The resin layer can be formed by applying a resin composition onto the colloidal crystal layer.

The resin that forms the resin layer is not particularly limited, and in consideration of excellent adhesion to core-shell-type resin fine particles, it is preferably an acrylic resin and more preferably a styrene acrylic resin. In addition, the resin layer is preferably a layer in which aqueous resin fine particles are formed into a film in order to prevent permeation into the colloidal crystal layer.

The method of producing aqueous resin fine particles is not particularly limited, and for example, particles can be produced by the following emulsion polymerization. First, an aqueous medium and a surfactant are put into a reaction tank, and the temperature is raised to a predetermined temperature. On the other hand, water, a surfactant and ethylenically unsaturated monomers including (meth)acrylic monomers are put into a dropwise-addition tank, and stirred to prepare an emulsion. Then, a radical polymerization initiator is added while the emulsion prepared is added dropwise in the reaction tank under a nitrogen atmosphere. After the reaction starts, polymer particle nuclei are generated, and the particles gradually grow to form acrylic resin fine particles.

For the ethylenically unsaturated monomers that can be used for producing aqueous resin fine particles, the description in the section of <Ethylenically unsaturated monomer> in the above <Primer layer> can be used.

In addition, for the radical polymerization initiator, the surfactant, and other components that can be used for producing aqueous resin fine particles, the description in the section of <Radical polymerization initiator>, <Surfactant>, and <Other components> in the above <Primer layer> can be used.

The aqueous resin fine particles preferably have a reactive group for forming cross-links, and ethylenically unsaturated monomers having a reactive group may be used as ethylenically unsaturated monomers. When the aqueous resin fine particles have a reactive group, cross-links inside the resin layer and cross-links between the resin layer and the colloidal crystal layer can be formed. The coating strength of the resin layer is improved according to the cross-links inside the resin layer, and the bonding between the resin layer and the colloidal crystal layer become more firmly bonded according to the cross-links between the resin layer and the colloidal crystal layer. Accordingly, the obtained laminate has excellent solvent resistance.

Cross-links inside the resin layer can be introduced by a method of reacting reactive groups of aqueous resin fine particles with each other or a method of reacting reactive groups of aqueous resin fine particles via a multifunctional cross-linking agent.

Cross-links between the resin layer and the colloidal crystal layer can be introduced by a method of reacting reactive groups of aqueous resin fine particles and core-shell-type resin fine particles with each other or a method of reacting reactive groups of aqueous resin fine particles and core-shell-type resin fine particles via a multifunctional cross-linking agent.

For the reactive group, the description in the section of <Ethylenically unsaturated monomer> in the above <Primer layer> can be used.

When the aqueous resin fine particles contain a ketone group, the content of the ketone group is preferably in a range of 0.05 to 0.3 mmol/g based on the mass of the aqueous resin fine particles. When the content is in a range 0.05 to 0.3 mmol/g, since cross-linking is formed without inhibiting fusion of aqueous resin fine particles, the coating strength of the resin layer is improved, and the colloidal crystal layer and the resin layer are bonded more firmly. In addition, since excessive cross-linking is inhibited, it does not adversely affect the fluidity of the shell of core-shell-type resin fine particles. Accordingly, the obtained laminate exhibits a clear color development change during a heat treatment, and the solvent resistance is improved.

The average particle size of aqueous resin fine particles is preferably in a range of 50 to 300 nm and more preferably in a range of 80 to 300 nm. The aqueous resin fine particles preferably have a glass transition point in a range of −30 to 30° C. When the average particle size and the glass transition point are within the above ranges, the aqueous resin fine particles are blocked by the surface layer of the colloidal crystal layer, and a resin component is prevented from permeating into the void parts of the colloidal crystal layer. In addition, because of its excellent film-forming properties, a uniform resin layer without coating unevennesses or cracks can be formed. Accordingly, the obtained laminate is excellent in the color development property and various film resistances (abrasion resistance and solvent resistance).

### [Resin Composition]

A method of forming a resin layer is not particularly limited, and for example, and the layer can be formed by applying a resin composition containing aqueous resin fine particles and water onto a colloidal crystal layer, and drying it as necessary. The aqueous resin fine particles that are dried and formed into a film are preferably a water-insoluble layer.

The thickness of the resin layer is not particularly limited, and is preferably 3 to 50 μm, and more preferably 5 to 20 μm in consideration of the color development property and productivity of the laminate.

When the thickness of the resin layer is 3 μm or more, a protective function of the laminate is sufficiently exhibited with the resin layer, and the abrasion resistance and water resistance of the laminate are improved.

In order to improve the color development property of the laminate, improve the sensitivity of color change, improve the coatability, and improve the coating physical property according to cross-linking, the resin composition may contain various additives such as achromatic black fine particles, a photothermal conversion agent, a hydrophilic solvent, and a cross-linking agent as long as it does not adversely affect physical properties of the colloidal crystal layer.

### {Achromatic Black Fine Particles}

The achromatic black fine particles have a function of absorbing scattered light in the laminate and making color development of the laminate clearer. In particular, when the laminate is used in backing printing specifications, it is effective to obtain clear color development. In addition, when the laminate is heated with a laser beam, the achromatic black fine particles in the resin layer absorb infrared rays, and thus heating of the core-shell-type resin fine particles in the adjacent colloidal crystal layer is accelerated, and the voids in the shells are filled more quickly, and therefore a clear color development change occurs according to a heat treatment.

For the achromatic black fine particles, the description in the section of <Achromatic black fine particles> in the above <Primer layer> can be used.

### {Hydrophilic Solvent}

For the hydrophilic solvent, the description in the section of <Hydrophilic solvent> in the above <Primer layer> can be used.

### {Cross-Linking Agent}

The cross-linking agent is not particularly limited, and the description in the section of <Cross-linking agent> in the above <Primer layer> can be used.

### {Photothermal Conversion Agent}

The photothermal conversion agent (provided that achromatic black fine particles are excluded) is not particularly limited, and the description in the section of {Photothermal conversion agent} in the above <Primer layer> can be used.

### <Laminate>

The laminate of the present invention is a laminate including a substrate, a primer layer, and a colloidal crystal layer that develops color due to light interference in this order, and the thickness of the colloidal crystal layer is in a range of 0.5 to 100 μm. The production method is not particularly limited, and is preferably a method including the following processes 1 and 2. When each layer is formed, a drying process may be provided as necessary.

Process 1) a process in which a primer composition is applied onto a substrate and dried as necessary to form a primer layer.
Process 2) a process in which a colloidal crystal layer composition containing core-shell-type resin fine particles and achromatic black fine particles is applied onto the primer layer formed in the process 1 and dried as necessary to form a colloidal crystal layer having a thickness of 0.5 to 100 μm.

When the laminate has a resin layer, it is preferable to perform the following process 3 after the process 2.

Process 3) a process in which a resin composition containing aqueous resin fine particles and water is applied onto the colloidal crystal layer formed in the process 2 and dried as necessary to form a resin layer.

The method of applying a primer composition, a colloidal crystal layer composition, and a resin composition is not particularly limited, and examples thereof include plateless printing methods such as an inkjet method, a spray method, a dipping method, and a spin coating method; plate printing methods using an offset gravure coater, a gravure coater, a doctor coater, a bar coater, a blade coater, a flexo coater, and a roll coater; and a stencil printing method such as screen printing, and the method can be appropriately selected. The primer composition, the colloidal crystal layer composition, and the resin composition may be solid printing or a pattern layer.

When the drying process is provided, the drying method is not particularly limited, for example, the method can be appropriately selected from among known methods such as a heat drying method, a hot air drying method, an infrared drying method, a microwave drying method, and a drum drying method. The drying methods may be used alone or two or more thereof may be used in combination, and it is preferable to use a hot air drying method in order to reduce damage to the substrate and perform drying efficiently.

The drying temperature of the primer composition and the resin composition is preferably in a range of 50 to 100° C., and the drying temperature of the colloidal crystal layer composition is preferably in a range of 25 to 80° C.

### [Substrate]

The substrate is not particularly limited, and can be selected from among known substrates. Examples of substrates include thermoplastic resin substrates such as a polyvinyl chloride sheet, polyethylene terephthalate (PET) film, polypropylene (PP) film, polyethylene (PE) film, nylon (Ny) film, polystyrene film, and polyvinyl alcohol film; metal substrates such as an aluminum foil; glass substrates; coated paper substrates; and cloth substrates.

Since the laminate of the present invention has a primer layer, even if a non-polar film substrate such as a polyethylene terephthalate film, a polypropylene film, or a polyethylene film, which has been difficult to fix due to peeling off of the colloidal crystal layer in the related art, is used, it is possible to exhibit excellent substrate conformability, abrasion resistance, water resistance, solvent resistance, and color development property.

The substrate has a surface that may be smooth or may have irregularities, and may be transparent, translucent, or opaque. When the colloidal crystal layer is visually observed from the side of the substrate, the substrate is preferably transparent. In addition, in order to make color development of the colloidal crystals clearer, the substrate may be colored in black or the like in advance or may be partially printed with a pigment ink or the like, or may be subjected to a surface treatment such as a corona treatment and a plasma treatment.

These substrates may be used alone or a laminate of two or more thereof may be used.

### <Heat-Sensitive Recording Body>

The heat-sensitive recording body of the present invention includes the laminate of the present invention. The laminate of the present invention has a feature in which the shells of the colloidal crystal layer are fluidized according to a heat treatment and fill the void parts. Accordingly, since the color development of the colloidal crystal layer fades and a clear color development change occurs, the laminate of the present invention can be used as the heat-sensitive recording body. The method for forming an image of the present invention includes a process in which the heat-sensitive recording body of the present invention is heated to make color development of the colloidal crystal layer fade.

The heat treatment method can be appropriately selected as long as the effects of the present invention are not impaired, and examples thereof include a method of applying a thermal head to a laminate using a thermal printer and heating it; a method of emitting a laser beam, absorbing light with achromatic black fine particles in the colloidal crystal layer and heating adjacent core-shell-type resin fine particles; and oven heating, microwave heating, and a boiling treatment.

Image formation with a laser is preferable because it enables image formation to be performed without scratching the substrate, the resin layer, or the non-image forming part. In addition, it is preferable to use an infrared laser because it has little adverse effect on the substrate, the resin forming the primer layer, the core-shell-type resin fine particles, or the resin that forms the resin layer. Examples of infrared laser markers include a CO₂ laser marker (a wavelength of 10,600 nm), a YVO₄ laser marker (a wavelength of 1,064 nm), a YAG laser marker (a wavelength of 1,064 nm), and a fiber laser marker (a wavelength of 1,090 nm).

The heating temperature can be appropriately changed depending on the design of core-shell-type resin fine particles, and is preferably in a range of 100 to 200° C., and more preferably in a range of 120° C. to 160° C. in consideration of storage stability, color development change during heating, thermal damage to the substrate and the like.

As long as the effects of the present invention are not impaired, the heat-sensitive recording body of the present invention may further have another layer, for example, a hard coat layer and/or an adhesive layer, or may be laminated with another separate substrate via these layers. In addition, these separate layers may be arranged on the side of the substrate or may be arranged on the side of the colloidal crystal layer. When the heat-sensitive recording body further has an adhesive layer, it can be used as an adhesive sheet.

### [Adhesive Layer]

The adhesive layer has a function of adhering the laminate of the present invention having a colloidal crystal layer to any adherend. The thickness of the adhesive layer is generally in a range of 5 to 100 μm.

The adhesive layer can be formed using a known pressure sensitive adhesive and is not particularly limited. The pressure sensitive adhesive can be appropriately selected depending on the type of the substrate and colloidal crystal layer, and preferably, it includes at least one resin selected from the group consisting of acrylic resins and urethane resins.

The resin that forms an adhesive layer preferably has a low content of unreacted components and residual solvents, and an aqueous resin is preferably used. If the content of unreacted components and residual solvents contained in the resin is low, it is possible to reduce the influence on the substrate, the colloidal crystal layer, and the resin layer. Here, the aqueous resin is a resin that can be dispersed or dissolved in an aqueous medium. In addition, the aqueous medium is an aqueous dispersion medium or an aqueous solvent, and includes a dispersion medium or a solvent that can be mixed with water in addition to water. The adhesive layer may contain various additives such as a cross-linking agent and a tackifier in order to impart an adhesive physical property.

### EXAMPLES

Hereinafter, the present invention will be described in more detail with reference to examples, but the following examples do not limit the scope of the present invention. Unless otherwise specified, “parts” and “%” indicate “parts by mass” and “mass %,” respectively. In addition, blanks in the tables indicate that the component is not added.

### [Acid Value]

The acid value was calculated by performing potentiometric titration with a potassium hydroxide/ethanol solution according to JIS K2501 using the dried resin. An automatic titrator COM-1600 (commercially available from Hiranuma Sangyo Co., Ltd.) was used for titration.

### [Glass Transition Point (Tg)]

The glass transition point was measured by a DSC (differential scanning calorimeter, commercially available from TA Instruments). Specifically, about 2 mg of a sample obtained by drying the resin was weighed out on an aluminum pan, the aluminum pan was set on a DSC measurement holder, and the base line shift (point of inflection) to the heat absorption side on the DSC curve obtained at a temperature rising condition of 5° C./min was read to obtain a glass transition point.

### [Average Particle Size]

A dispersing element of core-shell-type resin fine particles was diluted with water 500 times, and about 5 mL of the diluted solution was measured by a dynamic light scattering measurement method (measurement device: Nanotrac UPA, commercially available from MicrotracBel Corp.). The peak of the obtained volume particle size distribution data (histogram) was used as an average particle size. The coefficient of variation Cv value representing the variation in particle size was calculated by the following formula.

Cv value %=standard deviation of particle size/average particle size×100

### <Production of Aqueous Dispersion of Resin Forming the Primer Layer>

### Production Example 1

7.5 parts of styrene, 10.0 parts of benzyl methacrylate, 25.0 parts of methyl methacrylate, 16.0 parts of 2-ethylhexyl acrylate, 38.0 parts of n-butyl acrylate, 3.0 parts of methacrylic acid, 0.5 parts of 3-methacryloxypropyltriethoxysilane, 4.8 parts of an aqueous solution containing 20% of KH-10, and 40.4 parts of deionized water were mixed in advance and stirred to prepare an ethylenically unsaturated monomer emulsion.

68.9 parts of deionized water, 0.25 parts of an aqueous solution containing 20% of Aqualon KH-10 (commercially available from DKS Co., Ltd.) (hereinafter referred to as KH-10) as a reactive surfactant, and 3% of an emulsion were put into a reaction container including a stirrer, a thermometer, a dropping funnel, and a reflux container, the internal temperature was raised to 80° C., purging with nitrogen was sufficiently performed, and 2.0 parts of an aqueous solution containing 5% of potassium persulfate as an initiator was then added to initiate emulsion polymerization. While maintaining the internal temperature at 80° C., the remaining emulsion and 2.0 parts of an aqueous solution containing 5% of potassium persulfate were added dropwise over 3 hours, the mixture was additionally reacted for 4 hours to obtain an aqueous dispersion of the styrene acrylic resin. After the reaction was completed, 2.4 parts of 25% ammonia water was added for neutralization, and the solid content of the aqueous dispersion was adjusted to 45.0% with deionized water. The resin had an acid value of 19.5 mg KOH/g and a Tg of −8.8° C.

### Production Examples 2 to 7

Aqueous dispersions of styrene acrylic resins were obtained in the same manner as in Production Example 1 except that formulations were changed as shown in Table 1. After the reaction was completed, 25% ammonia water was added for neutralization so that it was equimolar with the carboxyl group in the resin. Then, the solid content was adjusted to 45.0% with deionized water.

TABLE 1

| | | Production | Production | Production | Production | Production | Production | Production |
|---|---|---|---|---|---|---|---|---|
| | | Example 1 | Example 2 | Example 3 | Example 4 | Example 5 | Example 6 | Example 7 |
| Ethylenically | Styrene | 7.5 | 17.0 | 10.0 | 15.0 | 15.0 | 12.0 | 12.0 |
| unsaturated | Benzyl methacrylate | 10.0 | | | 20.0 | 20.0 | | |
| monomer | Phenoxyethyl acrylate | | | 10.0 | | | 1.0 | 1.0 |
| | Methyl methacrylate | 25.0 | 2.0 | 20.0 | 31.0 | 31.4 | 2.0 | 2.0 |
| | n-Butyl methacrylate | | | 5.0 | | | | |
| | 2-Ethylhexyl acrylate | 16.0 | | 22.0 | | | | 6.0 |
| | Cyclohexyl | | 4.0 | | | | 4.0 | 4.0 |
| | methacrylate | | | | | | | |
| | Lauryl methacrylate | | | 2.0 | | | | |
| | n-Butyl acrylate | 38.0 | 74.8 | 25.0 | 30.0 | 30.0 | 78.0 | 72.0 |
| | Ethyl acrylate | | | | 2.0 | 2.0 | | |
| | Methacrylate | 3.0 | | | | | | |
| | Acrylic acid | | 2.0 | 2.0 | 1.0 | 0.6 | 2.0 | 2.0 |
| | 2-Hydroxyethyl | | | | 0.5 | 0.5 | | |
| | methacrylate | | | | | | | |
| | Diacetone acrylamide | | | 3.0 | | | | |
| | 3-Methacryloxypropyltriethoxysilane | 0.5 | 0.2 | 1.0 | 0.5 | 0.5 | 1.0 | 1.0 |
| Properties | Acid value mgKOH/g | 19.5 | 15.6 | 15.6 | 7.8 | 4.7 | 15.6 | 15.6 |
| | Tg ° C. | −8.8 | −29.3 | −14.0 | 26.2 | 26.2 | −34.2 | −35.5 |

### Production Example 8

185.0 parts of deionized water, 42.9 parts of JONCRYL67 (commercially available from BASF, a styrene acrylic resin Mw of 12,500 and an acid value of 213 mg KOH/g) as a polymer dispersant and 11.1 parts of 25% ammonia water were put into a reaction container including a stirrer, a thermometer, two dropping funnels, and a reflux container, the temperature was raised while stirring, and the polymer dispersant was dissolved. Under nitrogen reflux, the temperature was raised to 80° C., and a mixed solution containing 14.0 parts of styrene, 15.0 parts of n-butyl methacrylate, 30.0 parts of 2-ethylhexyl acrylate, 10.0 parts of cyclohexyl acrylate, 30.0 parts of n-butyl acrylate, and 1.0 part of glycidyl methacrylate was then added dropwise over 2 hours from one of the two dropping funnels. From the other funnel, 3.5 parts of an aqueous solution containing 20% of ammonium persulfate was added dropwise over 2 hours. After dropwise addition was completed, the mixture was additionally reacted for 5 hours to obtain an aqueous dispersion of the styrene acrylic resin. After the reaction was completed, the solid content was adjusted to 40.0% with deionized water. The obtained resin had an acid value of 63.9 mg KOH/g and a Tg of −1.3° C.

### Production Example 9

An aqueous dispersion of a styrene acrylic resin having a solid content of 40.0% was obtained in the same manner as in Production Example 8 except that the amount of JONCRYL67 added was changed to 53.8 parts, and the amount of 25% ammonia water was changed to 13.9 parts. The obtained resin had an acid value of 74.6 mg KOH/g and a Tg of 3.4° C.

### Production Example 10

An aqueous dispersion of a styrene acrylic resin having a solid content of 40.0% was obtained in the same manner as in Production Example 8 except that JONCRYL678 (commercially available from BASF, a styrene acrylic resin Mw of 8,500 and an acid value of 215 mg KOH/g) was used in place of JONCRYL67, the amount of deionized water added to the reaction container was changed to 334 parts, 177.8 parts of JONCRYL678 was used, and 46.3 parts of 25% ammonia water was used. The obtained resin had an acid value of 137.6 mg KOH/g and a Tg of 35.9° C.

### Production Example 11

An aqueous dispersion of a styrene acrylic resin having a solid content of 40.0% was obtained in the same manner as in Production Example 8 except that JONCRYL678 (commercially available from BASF, a styrene acrylic resin Mw of 8,500 and an acid value of 215 mg KOH/g) was used in place of JONCRYL67, the amount of deionized water added to the reaction container was 362 parts, 203 parts of JONCRYL678 was used, and 52.9 parts of 25% ammonia water was used. The obtained resin had an acid value of 144.1 mg KOH/g and a Tg of 38.4° C.

### Production Example 12

19.6 parts of PTG-2000SN (commercially available from Hodogaya Chemical Co., Ltd.: polytetramethylene glycol), 20.3 parts of P-2011 (commercially available from Kuraray Co., Ltd.: 3-methyl-1,5-pentanediol/adipic acid/terephthalic acid-based polyester polyol), 91.6 parts of C-2090 (commercially available from Kuraray Co., Ltd.: polycarbonate polyol), and 19.7 parts of dimethylolbutanoic acid as polyols; 48.8 parts of isophorone diisocyanate as a polyisocyanate; and 40.0 parts of methyl ethyl ketone and 10.0 parts of dipropylene glycol dimethyl ether as solvents were put into a reaction container including a stirrer, a thermometer, and a reflux container, and the temperature was raised to 78° C. while stirring under a nitrogen atmosphere. 0.02 parts of diisopropoxy bis(ethylacetoacetate)titanium as a catalyst was added thereto, and the mixture was reacted for 6 hours to obtain a urethane pre-polymer having isocyanate groups at both terminals. 13.5 parts of triethylamine as a neutralizing agent was added, 400 parts of deionized water and 2.4 parts of ethylene diamine as a chain extender were then added, and phase inversion to an aqueous phase was performed while removing the solvent under a reduced pressure condition. A chain extension reaction of isocyanate groups in an aqueous medium was promoted to prepare an aqueous dispersion of a urethane resin having a solid content of 30.0%. The obtained resin had an acid value of 37.4 mg KOH/g and a Tg of 94.0° C.

### Production Examples 13 to 15

Aqueous dispersions of urethane resins having a solid content of 30.0% were obtained in the same manner as in Production Example 9 except that the formulations were changed as shown in Table 2. Table 2 shows the acid value and Tg of the obtained resins.

TABLE 2

| | | Production | Production | Production | Production |
|---|---|---|---|---|---|
| | | Example 12 | Example 13 | Example 14 | Example 15 |
| Polyol | PTG-2000SN | 19.6 | 19.1 | 17.3 | 18.6 |
| | P-2011 | 20.3 | 19.8 | 18.0 | 19.3 |
| | C-2090 | 91.6 | 89.7 | 105.9 | 98.3 |
| Low-molecular-weight polyol | Neopentyl glycol | | | | 0.9 |
| | Dimethylolbutyric acid | 19.7 | 19.3 | 15.7 | 16.8 |
| Polyisocyanate | Isophorone diisocyanate | 48.8 | 52.0 | 43.1 | 46.2 |
| Chain extender | Ethylenediamine | 2.4 | 2.4 | 2.1 | 3.2 |
| Properties | Acid value mgKOH/g | 37.4 | 36.6 | 29.0 | 29.0 |
| | Tg ° C. | 94.0 | 101.0 | 67.0 | 75.0 |

The abbreviations in Table 2 are shown below.

PTG-2000SN: commercially available from Hodogaya Chemical Co., Ltd., polytetramethylene glycol (the number of functional groups of 2, a hydroxyl value of 57.0 mg KOH/g, and a molecular weight of 2,000)
P-2011: commercially available from Kuraray Co., Ltd., 3-methyl-1,5-pentanediol/adipic acid/terephthalic acid-based polyester polyol (the number of functional groups of 2, a hydroxyl value of 55.0 mg KOH/g, and a molecular weight of 2,000)
C-2090: commercially available from Kuraray Co., Ltd., polycarbonate polyol (the number of functional groups of 2, a hydroxyl value of 56.0 mg KOH/g, and a molecular weight of 2,000)

### Production Example 16

100 parts of AUROREN 350S (commercially available from Nippon Paper Industries Co., Ltd.: maleic anhydride-modified polypropylene-polyethylene copolymer) as a solid olefin resin, 100 parts of toluene, and 30.0 parts of NOIGEN TDS-120 (commercially available from DKS Co., Ltd.: polyoxyethylene tridodecyl ether HLB14.8) as a low-molecular-weight surfactant were put into a reaction container including a stirrer, a thermometer, and a reflux container, the temperature was raised to 100° C., and the resin was dissolved. After dissolution was completed, 5.0 parts of dimethylaminoethanol and 600.0 parts of deionized water were added as neutralizing agents. Then, while removing the solvent under a reduced pressure condition, phase inversion to an aqueous phase was performed, and an aqueous dispersion of an olefin resin having a solid content of 30.0% was obtained. The obtained aqueous resin had an acid value of 24.0 mg KOH/g and a Tg of −20° C.

### <Preparation of Aqueous Dispersion of Core-Shell-Type Resin Fine Particles>

### Production Example 17

First, 97.0 parts of styrene, 2.0 parts of acrylic acid, 1.0 part of 3-methacryloxypropyltrimethoxysilane, 5.0 parts of an aqueous solution containing 20% of KH-10, and 39.0 parts of deionized water were mixed and stirred to prepare a first-stage ethylenically unsaturated monomer emulsion. 95.0 parts of deionized water and 1.5% of the first-stage emulsion were put into a reaction container including a stirrer, a thermometer, a dropping funnel, and a reflux container. The internal temperature of the reaction container was raised to 70° C., purging with nitrogen was sufficiently performed, and 5.7 parts of an aqueous solution containing 2.5% of potassium persulfate as an initiator was then added to initiate polymerization. The internal temperature was raised to 80° C., and while maintaining the temperature, the remaining emulsion and 4.0 parts of an aqueous solution containing 2.5% of potassium persulfate were added dropwise over 2 hours and reacted to synthesize core particles.

Next, 17.0 parts of methyl methacrylate, 24.1 parts of n-butyl acrylate, 0.9 parts of acrylic acid, 2.1 parts of an aqueous solution containing 20% of KH-10, and 16.7 parts of deionized water were mixed and stirred to prepare a second-stage ethylenically unsaturated monomer emulsion. 20 minutes after the first-stage dropwise addition was completed, dropwise addition of the second-stage emulsion started. While maintaining the internal temperature at 80° C., the second-stage emulsion and 2.1 parts of an aqueous solution containing 2.5% of potassium persulfate were added dropwise over 2 hours and reacted to obtain an aqueous dispersion of core-shell-type resin fine particles. After the reaction, water was added and the solid content was adjusted to 45.0%. The average particle size of the obtained fine particles was 250 nm, the Cv value was 24.8%, the Tg of the core was 100.1° C., and the Tg of the shell was −6.2° C.

### Production Examples 18 to 42

Aqueous dispersions of core-shell-type resin fine particles were obtained in the same manner as in Production Example 17 except that the formulations were changed as shown in Tables 3 and 4. The amount of water in the reaction container was adjusted to 67% with respect to a total amount of ethylenically unsaturated monomers. The ethylenically unsaturated monomer emulsion was prepared by adding water so that the concentration of ethylenically unsaturated monomers in the emulsion was 69%, and the concentration of the surfactant was 0.69%. A total amount of the aqueous solution containing 2.5% of potassium persulfate was adjusted so that the amount of potassium persulfate was 0.2% with respect to a total amount of ethylenically unsaturated monomers. In the aqueous solution containing 2.5% of potassium persulfate, the proportions when the reaction started/when the first-stage emulsion was added dropwise/when the second-stage emulsion was added dropwise were the same as in Production Example 17.

In addition, in Production Example 25, a non-reactive surfactant HITENOL NF-08 (commercially available from DKS Co., Ltd., polyoxyethylene distyryl phenyl ether sulfate ester ammonium salt) was used in place of KH-10.

In Production Examples 36 and 38, the amount of the aqueous solution containing 20% of KH-10 put into the reaction container before the reaction started was changed to 5.2 parts, and additionally, the amount of the first-stage emulsion put into the reaction tank was changed to 2.6%.

In Production Example 39, 0.1 parts of octyl thioglycolate was additionally added to the second-stage ethylenically unsaturated monomer to prepare an emulsion.

In Production Examples 33, 34, and 35, AR-10 (commercially available from DKS Co., Ltd.) as an anionic reactive surfactant was used in place of KH-10. In addition, the amount of the first-stage emulsion put into the reaction tank was changed to 4.5%, 1.7%, and 3.7%.

Table 3 and Table 4 show the average particle size of the obtained core-shell-type resin fine particles, the Cv value, the Tg of the core, and the Tg of the shell.

TABLE 3

| | | | Production Example | | | | | | |
|---|---|---|---|---|---|---|---|---|---|
| | | | 17 | 18 | 19 | 20 | 21 | 22 | 23 |
| Ethylenically | Aromatic ethylenically | Styrene | 97.0 | 57.0 | 60.0 | 73.0 | 73.0 | 97.0 | 73.0 |
| unsaturated | unsaturated monomer | Benzyl methacrylate | | 10.0 | 10.0 | | | | |
| monomer | | Phenoxyethyl acrylate | | 0.5 | 0.5 | | | | |
| (bc) | Other ethylenically | Methyl methacrylate | | | | 10.0 | 10.0 | | 10.0 |
| Core | unsaturated monomers | n-Butyl methacrylate | | 21.0 | 18.0 | 8.0 | 8.0 | | 8.0 |
| | | 2-Ethylhexyl acrylate | | | | 3.0 | 3.0 | | 3.0 |
| | | Cyclohexyl methacrylate | | 8.0 | 8.0 | | | | |
| | | Lauryl methacrylate | | | | 2.0 | 2.0 | | 2.0 |
| | | Acrylic acid | 2.0 | 2.0 | 2.0 | 2.0 | 2.0 | 2.0 | 2.0 |
| | | 2-Hydroxyethyl methacrylate | | 0.5 | 0.5 | | | | |
| | | Acrylamide | | | | 1.0 | 1.0 | | 1.0 |
| | | Ethylene glycol dimethacrylate | | | | 1.0 | 1.0 | | 1.0 |
| | | 3-Methacryloxypropyltriethoxysilane | 1.0 | 1.0 | 1.0 | | | 1.0 | |
| Ethylenically | Ethylenically | Methyl methacrylate (LogKow = 1.13) | 17.0 | 15.0 | 15.0 | 5.0 | 5.0 | 17.0 | 5.0 |
| unsaturated | unsaturated monomer | Ethyl acrylate (LogKow = 1.08) | | 15.0 | 15.0 | 12.0 | 12.0 | | 12.0 |
| monomer | (s−1) LogKow = 1~2.5 | n-Butyl acrylate (LogKow = 2.23) | 24.1 | 15.0 | 15.0 | 10.0 | 12.0 | 24.9 | 7.5 |
| (bs) | Ethylenically | Methyl acrylate (LogKow = 0.59) | | 0.5 | 0.5 | | | | 4.5 |
| shell | unsaturated | Methoxyethyl acrylate (LogKow = 0.24) | | | | | | | |
| | monomer (s−2) | Acrylic acid (LogKow = 0.14) | 0.9 | 1.0 | 1.0 | 1.0 | 1.0 | 0.1 | 1.0 |
| | LogKow = less than 1 | 4-Hydroxybutyl acrylate (LogKow = 0.90) | | 0.5 | 0.5 | 1.0 | 1.0 | | 1.0 |
| | | Diacetone acrylamide (LogKow = 0.82) | | | | | | | |
| | Other ethylenically | Benzyl methacrylate (LogKow = 2.82) | | | | 5.0 | 4.0 | | 4.0 |
| | unsaturated monomers | n-Butyl methacrylate (LogKow = 2.79) | | | | 1.0 | 1.0 | | 1.0 |
| | LogKow > 2.5 | 2-Ethylhexyl acrylate (LogKow = 4.05) | | | | 5.0 | 4.0 | | 4.0 |

| | | | | | | | | |
|---|---|---|---|---|---|---|---|---|
| Core | Amount of aromatic ethylenically unsaturated monomer content % | 97.0 | 67.5 | 70.5 | 73.0 | 73.0 | 97.0 | 73.0 |
| properties | Tg ° C. | 100.1 | 73.3 | 75.9 | 81.7 | 81.7 | 100.1 | 81.7 |
| Shell | Ethylenically unsaturated monomer (s−1) content % | 97.9 | 95.7 | 95.7 | 67.5 | 72.5 | 99.8 | 61.3 |
| properties | Ethylenically unsaturated monomer (s−2) content % | 2.1 | 4.3 | 4.3 | 5.0 | 5.0 | 0.2 | 16.3 |
| | Tg ° C. | −6.2 | −3.8 | −3.8 | −18.5 | −20.3 | −8.7 | −12.9 |
| Fine | Average particle size nm | 250 | 263 | 264 | 242 | 241 | 252 | 243 |
| particles | Cv value % | 24.8 | 25.7 | 25.4 | 25.9 | 25.3 | 27.4 | 27.0 |
| properties | Content % of shell based on mass of core | 42.0 | 47.0 | 47.0 | 40.0 | 40.0 | 42.0 | 40.0 |

| | | | Production Example | | | | | |
|---|---|---|---|---|---|---|---|---|
| | | | 24 | 25 | 26 | 27 | 28 | 29 |
| Ethylenically | Aromatic ethylenically | Styrene | 73.0 | 97.0 | | 97.0 | 75.0 | 98.0 |
| unsaturated | unsaturated monomer | Benzyl methacrylate | | | | | | |
| monomer | | Phenoxyethyl acrylate | | | | | | |
| (bc) | Other ethylenically | Methyl methacrylate | 10.0 | | 77.0 | | 15.0 | |
| Core | unsaturated monomers | n-Butyl methacrylate | 8.0 | | | | | |
| | | 2-Ethylhexyl acrylate | 3.0 | | | | 7.0 | |
| | | Cyclohexyl methacrylate | | | 20.0 | | | |
| | | Lauryl methacrylate | 2.0 | | | | | |
| | | Acrylic acid | 2.0 | 2.0 | 2.0 | 2.0 | 1.0 | 1.0 |
| | | 2-Hydroxyethyl methacrylate | | | | | | |
| | | Acrylamide | 1.0 | | | | 1.0 | |
| | | Ethylene glycol dimethacrylate | 1.0 | | | | | 1.0 |
| | | 3-Methacryloxypropyltriethoxysilane | | 1.0 | 1.0 | 1.0 | 1.0 | |
| Ethylenically | Ethylenically | Methyl methacrylate (LogKow = 1.13) | 5.0 | 15.0 | 27.0 | 15.0 | 57.0 | |
| unsaturated | unsaturated monomer | Ethyl acrylate (LogKow = 1.08) | 12.0 | | | | | |
| monomer | (s−1) LogKow = 1~2.5 | n-Butyl acrylate (LogKow = 2.23) | 8.5 | 26.1 | 24.1 | 23.8 | 40.0 | 44.0 |
| (bs) | Ethylenically | Methyl acrylate (LogKow = 0.59) | 3.5 | | | | | |
| shell | unsaturated | Methoxyethyl acrylate (LogKow = 0.24) | | | | | | 1.0 |
| | monomer (s−2) | Acrylic acid (LogKow = 0.14) | 1.0 | 0.9 | 0.9 | 0.9 | 1.0 | 1.0 |
| | LogKow = less than 1 | 4-Hydroxybutyl acrylate (LogKow = 0.90) | 1.0 | | | | | |
| | | Diacetone acrylamide (LogKow = 0.82) | | | | 1.3 | | |
| | Other ethylenically | Benzyl methacrylate (LogKow = 2.82) | 4.0 | | | | | |
| | unsaturated monomers | n-Butyl methacrylate (LogKow = 2.79) | 1.0 | | | | | |
| | LogKow > 2.5 | 2-Ethylhexyl acrylate (LogKow = 4.05) | 4.0 | | | | | 14.0 |

| | | | | | | | |
|---|---|---|---|---|---|---|---|
| Core | Amount of aromatic ethylenically unsaturated monomer content % | 73.0 | 97.0 | 0.0 | 97.0 | 75.0 | 98.0 |
| properties | Tg ° C. | 81.7 | 100.1 | 96.4 | 100.1 | 83.3 | 100.1 |
| Shell | Ethylenically unsaturated monomer (s−1) content % | 63.8 | 97.9 | 98.3 | 94.6 | 99.0 | 73.3 |
| properties | Ethylenically unsaturated monomer (s−2) content % | 13.8 | 2.1 | 1.7 | 5.4 | 1.0 | 3.3 |
| | Tg ° C. | −14.6 | −12.5 | 9.8 | −7.5 | 18.6 | −56.4 |
| Fine | Average particle size nm | 240 | 239 | 273 | 255 | 289 | 267 |
| particles | Cv value % | 26.5 | 27.4 | 26.8 | 25.0 | 29.5 | 28.1 |
| properties | Content % of shell based on mass of core | 40.0 | 42.0 | 52.0 | 41.0 | 98.0 | 60.0 |

TABLE 4

| | | | Production Example | | | | | | |
|---|---|---|---|---|---|---|---|---|---|
| | | | 30 | 31 | 32 | 33 | 34 | 35 | 36 |
| Ethylenically | Aromatic ethylenically | Styrene | 90.0 | 50.0 | 54.0 | 90.0 | 90.0 | 90.0 | 75.0 |
| unsaturated | unsaturated monomer | Benzyl methacrylate | | 30.0 | | | | | |
| monomer | | Phenoxyethyl acrylate | | | 25.0 | | | | |
| (bc) | Other ethylenically | Methyl methacrylate | | | 14.0 | 7.0 | 7.0 | 7.0 | 15.0 |
| Core | unsaturated monomers | n-Butyl methacrylate | | 18.0 | | | | | |
| | | 2-Ethylhexyl acrylate | | | 4.0 | | | | 7.0 |
| | | Cyclohexyl methacrylate | 7.0 | | | | | | |
| | | Lauryl methacrylate | | | | | | | |
| | | Acrylic acid | 2.0 | 1.5 | 1.5 | 2.0 | 2.0 | 2.0 | 1.0 |
| | | 2-Hydroxyethyl methacrylate | | | 0.5 | | | | |
| | | Acrylamide | | | | | | | 1.0 |
| | | Ethylene glycol dimethacrylate | | | | | | | |
| | | 3-Methacryloxypropyltriethoxysilane | 1.0 | 0.5 | 1.0 | 1.0 | 1.0 | 1.0 | 1.0 |
| Ethylenically | Ethylenically unsaturated | Methyl methacrylate (LogKow = 1.13) | 10.0 | 35.0 | 20.0 | 17.0 | 17.0 | 17.0 | 85.5 |
| unsaturated | monomer (s−1) | Ethyl acrylate (LogKow = 1.08) | | | | | | | |
| monomer | LogKow = 1~2.5 | Acrylate (LogKow = 2.23) | 22.1 | 12.0 | 20.0 | 25.0 | 25.0 | 25.0 | 60.0 |
| (bs) | Ethylenically unsaturated | Methyl acrylate (LogKow = 0.59) | | | | | | | |
| shell | monomer (s−2) | Ethyl methoxyacrylate (LogKow = 0.24) | | | | | | | |
| | LogKow = less than 1 | Acrylic acid (LogKow = 0.14) | 0.9 | 0.5 | 1.5 | 1.0 | 1.0 | 1.0 | 1.0 |
| | | 4-Hydroxybutyl acrylate (LogKow = 0.90) | | | | | | | |
| | | Diacetone acrylamide (LogKow = 0.82) | | | | | | | |
| | Other ethylenically | Benzyl methacrylate (LogKow = 2.82) | | | | | | | |
| | unsaturated monomer | n-Butyl methacrylate (LogKow = 2.79) | | | 0.5 | | | | |
| | LogKow > 2.5 | 2-Ethylhexyl acrylate (LogKow = 4.05) | | 3.0 | | | | | |

| | | | | | | | | |
|---|---|---|---|---|---|---|---|---|
| Core | Amount of aromatic ethylenically unsaturated monomer content % | 90.0 | 80.0 | 79.0 | 90.0 | 90.0 | 90.0 | 75.0 |
| properties | Tg ° C. | 97.5 | 68.7 | 52.4 | 100.5 | 100.5 | 100.5 | 83.3 |
| Shell | Ethylenically unsaturated monomer (s−1) content % | 97.3 | 93.1 | 95.2 | 97.7 | 97.7 | 97.7 | 99.3 |
| properties | Ethylenically unsaturated monomer (s−2) content % | 2.7 | 1.0 | 3.6 | 2.3 | 2.3 | 2.3 | 0.7 |
| | Tg ° C. | −18.7 | 35.9 | 7.2 | −7.2 | −7.2 | −7.2 | 18.4 |
| Fine | Average particle size nm | 239 | 267 | 238 | 185 | 323 | 205 | 274 |
| particles | Cv value % | 26.7 | 26.4 | 26.5 | 26.4 | 28.5 | 25.9 | 26.9 |
| properties | Content % of shell based on mass of core | 33.0 | 50.5 | 42.0 | 43.0 | 43.0 | 43.0 | 146.5 |

| | | | Production Example | | | | | |
|---|---|---|---|---|---|---|---|---|
| | | | 37 | 38 | 39 | 40 | 41 | 42 |
| Ethylenically | Aromatic ethylenically | Styrene | 90.0 | 75.0 | 98.0 | 90.0 | 50.0 | 52.0 |
| unsaturated | unsaturated monomer | Benzyl methacrylate | | | | | 30.0 | |
| monomer | | Phenoxyethyl acrylate | | | | | | 25.0 |
| (bc) | Other ethylenically | Methyl methacrylate | | 15.0 | | | | 14.0 |
| Core | unsaturated monomers | n-Butyl methacrylate | | | | | 18.0 | |
| | | 2-Ethylhexyl acrylate | | 7.0 | | | | 6.0 |
| | | Cyclohexyl methacrylate | 7.0 | | | 7.0 | | |
| | | Lauryl methacrylate | | | | | | |
| | | Acrylic acid | 2.0 | 1.0 | 1.0 | 2.0 | 1.5 | 1.5 |
| | | 2-Hydroxyethyl methacrylate | | | | | | 0.5 |
| | | Acrylamide | | 1.0 | | | | |
| | | Ethylene glycol dimethacrylate | | | 1.0 | | | |
| | | 3-Methacryloxypropyltriethoxysilane | 1.0 | 1.0 | | 1.0 | 0.5 | 1.0 |
| Ethylenically | Ethylenically unsaturated | Methyl methacrylate (LogKow = 1.13) | 3.0 | 88.5 | | 2.0 | 37.0 | 20.0 |
| unsaturated | monomer (s−1) | Ethyl acrylate (LogKow = 1.08) | | | | | | |
| monomer | LogKow = 1~2.5 | Acrylate (LogKow = 2.23) | 8.0 | 62.5 | 41.5 | 7.0 | 10.0 | 20.0 |
| (bs) | Ethylenically unsaturated | Methyl acrylate (LogKow = 0.59) | | | | | | |
| shell | monomer (s−2) | Ethyl methoxyacrylate (LogKow = 0.24) | | | 1.0 | | | |
| | LogKow = less than 1 | Acrylic acid (LogKow = 0.14) | 0.3 | 1.2 | 1.0 | 0.2 | 0.5 | 1.5 |
| | | 4-Hydroxybutyl acrylate (LogKow = 0.90) | | | | | | |
| | | Diacetone acrylamide (LogKow = 0.82) | | | | | | |
| | Other ethylenically | Benzyl methacrylate (LogKow = 2.82) | | | | | | |
| | unsaturated monomer | n-Butyl methacrylate (LogKow = 2.79) | | | | | | 0.5 |
| | LogKow > 2.5 | 2-Ethylhexyl acrylate (LogKow = 4.05) | | | 15.5 | | 3.0 | |

| | | | | | | | |
|---|---|---|---|---|---|---|---|
| Core | Amount of aromatic ethylenically unsaturated monomer content % | 90.0 | 75.0 | 98.0 | 90.0 | 80.0 | 77.0 |
| properties | Tg ° C. | 97.5 | 83.3 | 100.1 | 97.5 | 68.7 | 47.6 |
| Shell | Ethylenically unsaturated monomer (s−1) content % | 97.3 | 99.2 | 70.3 | 97.8 | 93.1 | 95.2 |
| properties | Ethylenically unsaturated monomer (s−2) content % | 2.7 | 0.8 | 3.4 | 2.2 | 1.0 | 3.6 |
| | Tg ° C. | −23.3 | 18.2 | −60.9 | −29.5 | 43.3 | 7.2 |
| Fine | Average particle size nm | 212 | 278 | 262 | 234 | 269 | 243 |
| particles | Cv value % | 27.9 | 29.8 | 28.3 | 26.6 | 26.7 | 26.4 |
| properties | Content % of shell based on mass of core | 11.3 | 152.2 | 59.0 | 9.2 | 50.5 | 42.0 |

### <Preparation of Aqueous Dispersion of None-Core-Shell-Type Resin Fine Particles>

### Production Example 43

73.0 parts of styrene, 10.0 parts of methyl methacrylate, 8.0 parts of n-butyl methacrylate, 3.0 parts of 2-ethylhexyl acrylate, 2.0 parts of lauryl methacrylate, 1.0 part of acrylic acid, 1.0 part of acrylamide, 1.0 part of 3-methacryloxypropyltriethoxysilane, 5.0 parts of an aqueous solution containing 20% of KH-10, and 40.4 parts of water were mixed in advance and stirred to prepare an ethylenically unsaturated monomer emulsion.

68.9 parts of water was put into a reaction container including a stirrer, a thermometer, a dropping funnel, and a reflux container, and 3% of the emulsion was added. The internal temperature was raised to 70° C., purging with nitrogen was sufficiently performed, and 2.0 parts of an aqueous solution containing 5% of potassium persulfate as an initiator was then added to initiate emulsion polymerization. The internal temperature was raised to 80° C., and while maintaining the temperature, the remaining emulsion and 2.0 parts of an aqueous solution containing 5% of potassium persulfate were added dropwise over 3 hours and additionally reacted for 4 hours to obtain an aqueous dispersion of resin fine particles having a solid content of 45.0%. The obtained resin fine particles had an average particle size of 207 nm, a coefficient of variation Cv of 26.2%, and a Tg of 81.7° C.

### <Preparation of Aqueous Dispersion of Resin Fine Particles Forming Resin Layer>

### Production Example 44

15.0 parts of styrene, 30.0 parts of methyl methacrylate, 16.0 parts of 2-ethylhexyl acrylate, 35.0 parts of n-butyl acrylate, 2.0 parts of methacrylic acid, 1.0 part of acrylic acid, 1.0 part of 3-methacryloxypropyltriethoxysilane, 5.0 parts of an aqueous solution containing 20% of KH-10, and 40.4 parts of deionized water were mixed in advance and stirred to prepare an ethylenically unsaturated monomer emulsion.

68.9 parts of deionized water was put into a reaction container including a stirrer, a thermometer, a dropping funnel, and a reflux container, and 3% of the emulsion was added. The internal temperature was raised to 70° C., purging with nitrogen was sufficiently performed, and 2.0 parts of an aqueous solution containing 5% of potassium persulfate as an initiator was then added to initiate emulsion polymerization. The internal temperature was raised to 80° C., and while maintaining the temperature, the remaining emulsion and 2.0 parts of an aqueous solution containing 5% of potassium persulfate were added dropwise over 3 hours and additionally reacted for 4 hours to obtain an aqueous dispersion of resin fine particles having a solid content of 45.0%. The obtained aqueous resin fine particles had an average particle size of 196 nm and a Tg of −2.4° C.

### Production Examples 45 to 54

Aqueous dispersions of resin fine particles were obtained in the same manner as in Production Example 44 except that the formulations were changed as shown in Table 5. In Production Examples 45, 48, 49, and 50, the amount of the emulsion put into the reaction tank was changed to 1.5%, 5%, 1.5%, and 1.3%, respectively. In Production Examples 51, 52, 53, and 54, the amount of KH-10 was set to 6.0 parts, 6.3 parts, 7.0 parts, and 6.9 parts, respectively. Table 5 shows the average particle size and Tg of the obtained resin fine particles.

TABLE 5

| | | Production Example | | | | | | | | | | |
|---|---|---|---|---|---|---|---|---|---|---|---|---|
| | | 44 | 45 | 46 | 47 | 48 | 49 | 50 | 51 | 52 | 53 | 54 |
| Ethylenically | Styrene | 15.0 | 20.0 | | 15.0 | | 20.0 | 20.0 | | | | |
| unsaturated | Benzyl methacrylate | | | 10.0 | | 10.0 | | | 10.0 | 10.0 | 10.0 | 10.0 |
| monomer | Phenoxyethyl acrylate | | | 2.5 | | 2.5 | | | 2.5 | 2.5 | 2.5 | 2.5 |
| | Methyl methacrylate | 30.0 | 30.0 | | 30.0 | | 33.0 | 30.0 | | | | |
| | n-Butyl methacrylate | | 20.0 | 23.0 | | 19.0 | 20.0 | 20.0 | 22.0 | 22.0 | 22.0 | 22.0 |
| | 2-Ethylhexyl acrylate | 16.0 | | 25.0 | 16.0 | 29.0 | | | 26.0 | 26.0 | 26.0 | 26.0 |
| | Cyclohexyl methacrylate | | | 5.0 | | 5.0 | | | 5.0 | 5.0 | 5.0 | 5.0 |
| | Lauryl methacrylate | | | | | | | | | | | |
| | n-Butyl acrylate | 35.0 | 26.0 | 30.0 | 32.0 | 30.0 | 23.0 | 26.0 | 30.0 | 30.0 | 30.0 | 30.0 |
| | Ethyl acrylate | | | | | | | | | | | |
| | Methacrylate | 2.0 | 1.0 | 2.0 | 2.0 | 2.0 | 1.0 | 1.0 | 2.0 | 2.0 | 2.0 | 2.0 |
| | Acrylic acid | 1.0 | 2.0 | | 1.0 | | 2.0 | 2.0 | | | | |
| | 2-Hydroxyethyl methacrylate | | | 1.0 | | 1.0 | | | 1.0 | 1.0 | 1.0 | 1.0 |
| | Diacetone acrylamide | | | | 3.0 | | | | | | | |
| | 3-Methacryloxypropyltriethoxysilane | 1.0 | 1.0 | 1.5 | 1.0 | 1.5 | 1.0 | 1.0 | 1.5 | 1.5 | 1.5 | 1.5 |
| Properties | Average particle size nm | 196 | 290 | 193 | 180 | 154 | 289 | 305 | 84 | 77 | 48 | 54 |
| | Resin Tg ° C. | −2.4 | 29.1 | −27.9 | 1.5 | −31.5 | 34.5 | 29.1 | −28.8 | −28.8 | −28.8 | −28.8 |

### <Preparation of Aqueous Dispersion of Resin Fine Particles Forming Adhesive Layer>

### Production Example 55

97.5 parts of 2-ethylhexyl acrylate, 2.0 parts of acrylic acid, 0.5 parts of 3-methacryloxypropyltriethoxysilane, 0.03 parts of octyl thioglycolate, 7.0 parts of an aqueous solution containing 20% of Newcol RA9612 (polyoxyethylene alkyl ether sulfate ester ammonium salt, commercially available from Nippon Nyukazai Co., Ltd.), and 40.4 parts of deionized water were mixed in advance and stirred to prepare an ethylenically unsaturated monomer emulsion.

68.9 parts of deionized water was put into a reaction container including a stirrer, a thermometer, a dropping funnel, and a reflux container, and 1% of the emulsion was added. The internal temperature was raised to 80° C., purging with nitrogen was sufficiently performed, and 2.0 parts of an aqueous solution containing 5% of ammonium persulfate as an initiator was then added to initiate emulsion polymerization. While maintaining the internal temperature at 80° C., the remaining emulsion and 2.0 parts of an aqueous solution containing 5% of ammonium persulfate were added dropwise over 3 hours and additionally reacted for 8 hours to obtain an aqueous dispersion of resin fine particles. After the reaction was completed, 1.9 parts of 25% ammonia water was added for neutralization, and the solid content was adjusted to 45.0% with deionized water. The obtained resin had an acid value of 15.6 mg KOH/g and a Tg of −71.0° C.

### <Preparation of Primer Composition>

### Production Example 56

2.0 parts of isopropyl alcohol was added to 100 parts of the aqueous dispersion of the resin obtained in Production Example 1 and stirred to prepare a primer composition.

### Production Examples 57 to 74

Primer compositions were prepared in the same manner as in Production Example 56 except that the formulations were changed as shown in Table 6.

TABLE 6

| | | Production | Production | Production | Production | Production | Production | Production | Production | Production |
|---|---|---|---|---|---|---|---|---|---|---|
| | | Example | Example | Example | Example | Example | Example | Example | Example | Example |
| | | 56 | 57 | 58 | 59 | 60 | 61 | 62 | 63 | 64 |
| Aqueous | | Production | Production | Production | Production | Production | Production | Production | Production | Production |
| dispersion of | | Example | Example | Example | Example | Example | Example | Example | Example | Example |
| resin that forms | | 1 | 1 | 2 | 3 | 4 | 5 | 6 | 7 | 8 |
| primer layer | | 100 | 100 | 100 | 100 | 100 | 100 | 100 | 100 | 100 |
| Solvent | Isopropyl | 2.0 | 2.0 | | | 0.5 | 0.5 | | | 1.0 |
| | alcohol | | | | | | | | | |
| Solvent | Diethylene | | | | 0.5 | 0.5 | 0.5 | | | |
| | glycol | | | | | | | | | |
| | monobutyl | | | | | | | | | |
| | ether | | | | | | | | | |
| Cross-linking | Adipic acid | | | | 1.0 | | | | | |
| agent | dihydrazide | | | | | | | | | |
| | Denacol | | | | | | | | | |
| | EX-614B | | | | | | | | | |
| | Carbodilite | | | | | | | | | |
| | V-02 | | | | | | | | | |
| Achromatic | CW-1 | | 9.0 | | | | | | | |
| black | | | | | | | | | | |
| fine | | | | | | | | | | |
| particles | | | | | | | | | | |
| | | Production | Production | Production | Production | Production | Production | Production | Production | Production |
| | | Example | Example | Example | Example | Example | Example | Example | Example | Example |
| | | 65 | 66 | 67 | 68 | 69 | 70 | 71 | 72 | 73 |
| Aqueous | | Production | Production | Production | Production | Production | Production | Production | Production | Production |
| dispersion of | | Example | Example | Example | Example | Example | Example | Example | Example | Example |
| resin that forms | | 8 | 8 | 9 | 10 | 11 | 12 | 13 | 14 | 15 |
| primer layer | | 100 | 100 | 100 | 100 | 100 | 100 | 100 | 100 | 100 |
| Solvent | Isopropyl | | | 1.0 | 1.0 | 1.0 | 2.0 | 2.0 | 2.0 | 2.0 |
| | alcohol | | | | | | | | | |
| Solvent | Diethylene | | | | | | 0.8 | 0.8 | 0.8 | 0.8 |
| | glycol | | | | | | | | | |
| | monobutyl | | | | | | | | | |
| | ether | | | | | | | | | |
| Cross-linking | Adipic acid | | | | | | | | | |
| agent | dihydrazide | | | | | | | | | |
| | Denacol | 1.0 | | | | | | | | |
| | EX-614B | | | | | | | | | |
| | Carbodilite | | 2.5 | | | | | | | |
| | V-02 | | | | | | | | | |
| Achromatic | CW-1 | | | | | | | | | |
| black | | | | | | | | | | |
| fine | | | | | | | | | | |
| particles | | | | | | | | | | |

The abbreviations in Table 6 are shown below.
Denacol EX-614B: commercially available from Nagase ChemteX Corporation, sorbitol polyglycidyl ether, an epoxy equivalent of 173 g/eq, and a non-volatile component of 100% Carbodilite V-02: commercially available from Nisshinbo Chemical Inc., an aqueous dispersion of a polycarbodiimide, a carbodiimide equivalent of 445, and a non-volatile component of 40% CW-1: commercially available from Orient Chemical Industries Co., Ltd., BONJET BLACK CW-1, an aqueous dispersion of surface-modified carbon black, an average particle size of 62 nm, and a solid content of 20.0%

### <Preparation of Colloidal Crystal Layer Composition>

### Production Example 75

2.3 parts of BONJET BLACK CW-1 (commercially available from Orient Chemical Industries Co., Ltd., surface-modified carbon black, an average particle size of 62 nm, and a solid content of 20.0%) was added to 100 parts of the aqueous dispersion of the core-shell-type resin fine particles in Production Example 13 and stirred to prepare a colloidal crystal layer composition.

### Production Examples 76 to 105

Colloidal crystal layer compositions were prepared in the same methods as in Production Example 75 except that the formulations were changed as shown in Table 7.

TABLE 7

| | | Production | Production | Production | Production | Production | Production | Production | Production | Production |
|---|---|---|---|---|---|---|---|---|---|---|
| | | Example | Example | Example | Example | Example | Example | Example | Example | Example |
| | | 75 | 76 | 77 | 78 | 79 | 80 | 81 | 82 | 83 |
| Aqueous dispersion | | Production | Production | Production | Production | Production | Production | Production | Production | Production |
| of core-shell- | | Example | Example | Example | Example | Example | Example | Example | Example | Example |
| type resin | | 17 | 18 | 19 | 20 | 21 | 22 | 23 | 24 | 25 |
| fine particles | | 100 | 100 | 100 | 100 | 100 | 100 | 100 | 100 | 100 |
| Achromatic | CW-1 | 2.3 | 2.3 | 2.3 | 2.3 | 2.3 | 2.3 | 2.3 | 2.3 | 2.3 |
| black fine | | | | | | | | | | |
| particles | | | | | | | | | | |
| Cross- | Adipic | | | | | | | | | |
| linking | acid | | | | | | | | | |
| agent | dihydrazide | | | | | | | | | |
| | | Production | Production | Production | Production | Production | Production | Production | Production | Production |
| | | Example | Example | Example | Example | Example | Example | Example | Example | Example |
| | | 84 | 85 | 86 | 87 | 88 | 89 | 90 | 91 | 92 |
| Aqueous dispersion | | Production | Production | Production | Production | Production | Production | Production | Production | Production |
| of core-shell- | | Example | Example | Example | Example | Example | Example | Example | Example | Example |
| type resin | | 26 | 27 | 28 | 29 | 30 | 31 | 32 | 33 | 34 |
| fine particles | | 100 | 100 | 100 | 100 | 100 | 100 | 100 | 100 | 100 |
| Achromatic | CW-1 | 2.3 | 2.3 | 2.8 | 2.3 | 2.3 | 2.3 | 2.3 | 2.3 | 2.8 |
| black fine | | | | | | | | | | |
| particles | | | | | | | | | | |
| Cross- | Adipic | | | | | | | | | |
| linking | acid | | 0.5 | | | | | | | |
| agent | dihydrazide | | | | | | | | | |
| | | Production | Production | Production | Production | Production | Production | Production | Production | Production |
| | | Example | Example | Example | Example | Example | Example | Example | Example | Example |
| | | 93 | 94 | 95 | 96 | 97 | 98 | 99 | 100 | 101 |
| Aqueous dispersion | | Production | Production | Production | Production | Production | Production | Production | Production | Production |
| of core-shell- | | Example | Example | Example | Example | Example | Example | Example | Example | Example |
| type resin | | 35 | 36 | 37 | 38 | 39 | 40 | 41 | 42 | 13 |
| fine particles | | 100 | 100 | 100 | 100 | 100 | 100 | 100 | 100 | 100 |
| Achromatic | CW-1 | 2.3 | 2.3 | 2.3 | 2.3 | 2.3 | 2.3 | 2.3 | 2.3 | 0.5 |
| black fine | | | | | | | | | | |
| particles | | | | | | | | | | |
| Cross- | Adipic | | | | | | | | | |
| linking | acid | | | | | | | | | |
| agent | dihydrazide | | | | | | | | | |

| | | | Production | Production | Production | Production |
|---|---|---|---|---|---|---|
| | | | Example | Example | Example | Example |
| | | | 102 | 103 | 104 | 105 |
| Aqueous dispersion or | | | Production | Production | Production | Production |
| core-shell type | | | Example | Example | Example | Example |
| or non-core-shell | | | 13 | 13 | 13 | 43 |
| type resin fine particles | | | 100 | 100 | 100 | 100 |
| | Achromatic | CW-1 | 0.7 | 5.8 | 6.8 | 2.3 |
| | black fine | | | | | |
| | particles | | | | | |
| | Cross- | Adipic | | | | |
| | linking | acid | | | | |
| | agent | dihydrazide | | | | |

### Production Example 106

45 parts of the aqueous dispersion of the resin fine particles in Production Example 44 as a binder and 2.3 parts of CW-1 (commercially available from Orient Chemical Industries Co., Ltd., surface-modified carbon black, an average particle size of 62 nm, and a solid content of 20.0%) were added to 100 parts of the aqueous dispersion of the none-core-shell-type resin fine particles in Production Example 43 and stirred to prepare a colloidal crystal layer composition.

### <Preparation of Resin Composition>

### Production Example 107

0.2 parts of isopropyl alcohol and 9.0 parts of CW-1 (commercially available from Orient Chemical Industries Co., Ltd., surface-modified carbon black, an average particle size of 62 nm, a solid content of 20.0%) were added to 100 parts of the aqueous dispersion of aqueous resin fine particles obtained in Production Example 44 and stirred to prepare a resin composition.

### Production Examples 108 to 118

Resin compositions were prepared in the same manner as in Production Example 107 except that formulations were changed as shown in Table 8.

TABLE 8

| | | Production | Production | Production | Production | Production | Production | Production |
|---|---|---|---|---|---|---|---|---|
| | | Example | Example | Example | Example | Example | Example | Example |
| | | 107 | 108 | 109 | 110 | 111 | 112 | 113 |
| Aqueous dispersion | | Production | Production | Production | Production | Production | Production | Production |
| of resin | | Example | Example | Example | Example | Example | Example | Example |
| fine particles | | 44 | 44 | 45 | 46 | 47 | 48 | 49 |
| that form resin layer | | 100 | 100 | 100 | 100 | 100 | 100 | 100 |
| Solvent | Isopropyl | 0.2 | | 1.0 | | | | 1.0 |
| | alcohol | | | | | | | |
| Cross-linking | Adipic acid | | | | | 0.8 | | |
| agent | dihydrazide | | | | | | | |
| Achromatic | CW-1 | 9.0 | | | | | | |
| black | | | | | | | | |
| fine | | | | | | | | |
| particles | | | | | | | | |

| | | Production | Production | Production | Production | Production |
|---|---|---|---|---|---|---|
| | | Example | Example | Example | Example | Example |
| | | 114 | 115 | 116 | 117 | 118 |
| Aqueous dispersion | | Production | Production | Production | Production | Production |
| of resin | | Example | Example | Example | Example | Example |
| fine particles | | 50 | 51 | 52 | 53 | 54 |
| that form resin layer | | 100 | 100 | 100 | 100 | 100 |
| Solvent | Isopropyl | 1.0 | | | | |
| | alcohol | | | | | |
| Cross-linking | Adipic acid | | | | | |
| agent | dihydrazide | | | | | |
| Achromatic | CW-1 | | | | | |
| black | | | | | | |
| fine | | | | | | |
| particles | | | | | | |

### <Production of Laminate>

### Example 1

The primer composition of Production Example 56 was applied to a corona treatment surface of a biaxially oriented polypropylene (OPP) film (FOR, commercially available from Futamura Chemical Co., Ltd., a thickness of 20 μm) with a bar coater so that the thickness after drying was 3.0 μm and then dried in an oven at 50° C. for 3 minutes to form a primer layer. Next, the colloidal crystal layer composition of Production Example 75 was applied onto the primer layer with a bar coater so that the thickness after drying was 9.0 μm and dried at 40° C. for 5 minutes to obtain a laminate having a configuration of OPP/primer layer/colloidal crystal layer.

### Examples 2 to 55 and Comparative Examples 1 to 12

Laminates were obtained in the same manner as in Example 1 except that combinations and thicknesses were changed as shown in Table 9A and Table 9B.

In Examples 11 and 19 and Comparative Example 1, a colloidal crystal layer composition was applied and then naturally dried at room temperature for 1 hour to form a colloidal crystal layer.

In Examples 44 to 55, a resin composition was applied onto the colloidal crystal layer with a bar coater and dried in an oven at 50° C. for 5 minutes to form a resin layer.

In Comparative Example 10, the dispersing element of Production Example 17 containing no achromatic black fine particles was used as the colloidal crystal layer composition.

In Comparative Example 12, the colloidal crystal layer composition was directly applied onto the substrate.

TABLE 9A

| | Example | Example | Example | Example | Example | Example | Example |
|---|---|---|---|---|---|---|---|
| | 1 | 2 | 3 | 4 | 5 | 6 | 7 |
| Substrate | OPP | OPP | OPP | OPP | OPP | OPP | OPP |
| Primer | Production | Production | Production | Production | Production | Production | Production |
| composition | Example 56 | Example 56 | Example 56 | Example 56 | Example 56 | Example 56 | Example 56 |
| Colloidal | Production | Production | Production | Production | Production | Production | Production |
| crystal layer | Example 75 | Example 76 | Example 77 | Example 78 | Example 79 | Example 80 | Example 81 |
| composition | | | | | | | |
| Resin | | | | | | | |
| composition | | | | | | | |
| Primer layer | 3.0 | 3.0 | 3.0 | 3.0 | 3.0 | 3.0 | 3.0 |
| thickness (μm) | | | | | | | |
| Colloidal | 9.0 | 9.0 | 9.0 | 9.0 | 9.0 | 9.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |
| | Example | Example | Example | Example | Example | Example | Example |
| | 8 | 9 | 10 | 11 | 12 | 13 | 14 |
| Substrate | OPP | OPP | OPP | OPP | OPP | OPP | OPP |
| Primer | Production | Production | Production | Production | Production | Production | Production |
| composition | Example 56 | Example 56 | Example 56 | Example 56 | Example 56 | Example 56 | Example 56 |
| Colloidal | Production | Production | Production | Production | Production | Production | Production |
| crystal layer | Example 82 | Example 83 | Example 84 | Example 86 | Example 87 | Example 88 | Example 89 |
| composition | | | | | | | |
| Resin | | | | | | | |
| composition | | | | | | | |
| Primer layer | 3.0 | 3.0 | 3.0 | 3.0 | 3.0 | 3.0 | 3.0 |
| thickness (μm) | | | | | | | |
| Colloidal | 9.0 | 9.0 | 9.0 | 9.0 | 9.0 | 9.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |
| | Example | Example | Example | Example | Example | Example | Example |
| | 15 | 16 | 17 | 18 | 19 | 20 | 21 |
| Substrate | OPP | OPP | OPP | OPP | OPP | OPP | OPP |
| Primer | Production | Production | Production | Production | Production | Production | Production |
| composition | Example 56 | Example 56 | Example 56 | Example 56 | Example 56 | Example 56 | Example 56 |
| Colloidal | Production | Production | Production | Production | Production | Production | Production |
| crystal layer | Example 90 | Example 91 | Example 92 | Example 93 | Example 94 | Example 95 | Example 100 |
| composition | | | | | | | |
| Resin | | | | | | | |
| composition | | | | | | | |
| Primer layer | 3.0 | 3.0 | 3.0 | 3.0 | 3.0 | 3.0 | 3.0 |
| thickness (μm) | | | | | | | |
| Colloidal | 9.0 | 9.0 | 9.0 | 9.0 | 9.0 | 9.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |
| | Example | Example | Example | Example | Example | Example | Example |
| | 22 | 23 | 24 | 25 | 26 | 27 | 28 |
| Substrate | OPP | OPP | OPP | OPP | OPP | OPP | OPP |
| Primer | Production | Production | Production | Production | Production | Production | Production |
| composition | Example 56 | Example 56 | Example 56 | Example 56 | Example 56 | Example 56 | Example 58 |
| Colloidal | Production | Production | Production | Production | Production | Production | Production |
| crystal layer | Example 101 | Example 102 | Example 103 | Example 104 | Example 75 | Example 75 | Example 75 |
| composition | | | | | | | |
| Resin | | | | | | | |
| composition | | | | | | | |
| Primer layer | 3.0 | 3.0 | 3.0 | 3.0 | 3.0 | 3.0 | 2.0 |
| thickness (μm) | | | | | | | |
| Colloidal | 9.0 | 9.0 | 9.0 | 9.0 | 0.6 | 97.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |
| | Example | Example | Example | Example | Example | Example | Example |
| | 29 | 30 | 31 | 32 | 33 | 34 | 35 |
| Substrate | OPP | OPP | OPP | OPP | OPP | OPP | OPP |
| Primer | Production | Production | Production | Production | Production | Production | Production |
| composition | Example 59 | Example 60 | Example 61 | Example 62 | Example 64 | Example 65 | Example 66 |
| Colloidal | Production | Production | Production | Production | Production | Production | Production |
| crystal layer | Example 85 | Example 75 | Example 75 | Example 75 | Example 75 | Example 75 | Example 75 |
| composition | | | | | | | |
| Resin | | | | | | | |
| composition | | | | | | | |
| Primer layer | 3.0 | 3.0 | 3.0 | 0.50 | 3.0 | 3.0 | 3.0 |
| thickness (μm) | | | | | | | |
| Colloidal | 9.0 | 9.0 | 9.0 | 9.0 | 9.0 | 9.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |
| | Example | Example | Example | Example | Example | Example | Example |
| | 36 | 37 | 38 | 39 | 40 | 41 | 42 |
| Substrate | OPP | OPP | OPP | PET | PET | PET | OPP |
| Primer | Production | Production | Production | Production | Production | Production | Production |
| composition | Example 67 | Example 68 | Example 69 | Example 70 | Example 72 | Example 73 | Example 74 |
| Colloidal | Production | Production | Production | Production | Production | Production | Production |
| crystal layer | Example 75 | Example 75 | Example 75 | Example 75 | Example 75 | Example 75 | Example 75 |
| composition | | | | | | | |
| Resin | | | | | | | |
| composition | | | | | | | |
| Primer layer | 3.0 | 3.0 | 3.0 | 10 | 10 | 10 | 50 |
| thickness (μm) | | | | | | | |
| Colloidal | 9.0 | 9.0 | 9.0 | 9.0 | 9.0 | 9.0 | 9.0 |
| crystal layer | | | | | | | |
| thickness (μm) | | | | | | | |
| Resin layer | | | | | | | |
| thickness (μm) | | | | | | | |
| Presence of | Yes | Yes | Yes | Yes | Yes | Yes | Yes |
| voids | | | | | | | |

TABLE 9B

| | Example | Example | Example | Example | Example | Example | Example |
|---|---|---|---|---|---|---|---|
| | 43 | 44 | 45 | 46 | 47 | 48 | 49 |
| Substrate | OPP | OPP | OPP | OPP | OPP | OPP | OPP |
| Primer | Production | Production | Production | Production | Production | Production | Production |
| composition | Example 57 | Example 56 | Example 56 | Example 56 | Example 56 | Example 59 | Example 56 |
| Colloidal crystal | Production | Production | Production | Production | Production | Production | Production |
| layer composition | Example 75 | Example 75 | Example 75 | Example 75 | Example 75 | Example 85 | Example 75 |
| Resin | | Production | Production | Production | Production | Production | Production |
| composition | | Example 107 | Example 108 | Example 109 | Example 110 | Example 111 | Example 112 |
| Primer layer | 5.0 | 3.0 | 3.0 | 3.0 | 3.0 | 3.0 | 3.0 |
| thickness (μm) | | | | | | | |
| Colloidal crystal layer | 9.0 | 9.0 | 9.0 | 9.0 | 9.0 | 9.0 | 9.0 |
| thickness (μm) | | | | | | | |
| Resin layer | | 10 | 10 | 20 | 5.0 | 3.0 | 10 |
| thickness (μm) | | | | | | | |
| Presence of voids | Yes | Yes | Yes | Yes | Yes | Yes | Yes |

| | Example | Example | Example | Example | Example | Example |
|---|---|---|---|---|---|---|
| | 50 | 51 | 52 | 53 | 54 | 55 |
| Substrate | OPP | OPP | OPP | OPP | OPP | OPP |
| Primer | Production | Production | Production | Production | Production | Production |
| composition | Example 56 | Example 56 | Example 56 | Example 56 | Example 56 | Example 56 |
| Colloidal crystal | Production | Production | Production | Production | Production | Production |
| layer composition | Example 75 | Example 75 | Example 75 | Example 75 | Example 75 | Example 75 |
| Resin | Production | Production | Production | Production | Production | Production |
| composition | Example 113 | Example 114 | Example 115 | Example 116 | Example 117 | Example 118 |
| Primer layer | 3.0 | 3.0 | 3.0 | 3.0 | 3.0 | 3.0 |
| thickness (μm) | | | | | | |
| Colloidal crystal layer | 9.0 | 9.0 | 9.0 | 9.0 | 9.0 | 9.0 |
| thickness (μm) | | | | | | |
| Resin layer | 50 | 10 | 10 | 10 | 10 | 10 |
| thickness (μm) | | | | | | |
| Presence of voids | Yes | Yes | Yes | Yes | Yes | Yes |

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Substrate | OPP | OPP | OPP | OPP | OPP | OPP | OPP |
| Primer composition | Production | Production | Production | Production | Production | Production | Production |
| | Example 56 | Example 56 | Example 56 | Example 56 | Example 56 | Example 56 | Example 56 |
| Colloidal crystal | Production | Production | Production | Production | Production | Production | Production |
| layer composition | Example 96 | Example 97 | Example 98 | Example 99 | Example 105 | Example 75 | Example 75 |
| Resin composition | | | | | | | |
| Primer layer | 3.0 | 3.0 | 3.0 | 3.0 | 3.0 | 3.0 | 3.0 |
| thickness (μm) | | | | | | | |
| Colloidal crystal | 9.0 | 9.0 | 9.0 | 9.0 | 9.0 | 0.40 | 103 |
| layer thickness (μm) | | | | | | | |
| Resin layer | | | | | | | |
| thickness (μm) | | | | | | | |
| Presence of voids | Yes | Yes | Yes | Yes | Yes | Yes | Yes |

| | Comparative | Comparative | Comparative | Comparative | Comparative | Comparative |
|---|---|---|---|---|---|---|
| | Example 8 | Example 9 | Example 10 | Example 11 | Example 12 | Example 13 |
| Substrate | OPP | PET | OPP | OPP | OPP | OPP |
| Primer composition | Production | Production | Production | Production | | Production |
| | Example 63 | Example 71 | Example 56 | Example 56 | | Example 56 |
| Colloidal crystal | Production | Production | Production | Production | Production | Production |
| layer composition | Example 75 | Example 75 | Example 17 | Example 106 | Example 75 | Example 75 |
| Resin composition | | | | | | PVA |
| Primer layer | 0.5 | 10 | 3.0 | 3.0 | 3.0 | 3.0 |
| thickness (μm) | | | | | | |
| Colloidal crystal | 9.0 | 9.0 | 9.0 | 9.0 | 9.0 | 9.0 |
| layer thickness (μm) | | | | | | |
| Resin layer | | | | | | |
| thickness (μm) | | | | | | |
| Presence of voids | Yes | Yes | Yes | Yes | Yes | No |

The abbreviations in Table 9A and Table 9B are shown below.

OPP: (FOR, commercially available from Futamura Chemical Co., Ltd.: biaxially oriented polypropylene film, a thickness of 20 μm)

PET (E5101, commercially available from Toyobo Co., Ltd.: polyethylene terephthalate film, a thickness of 25 μm)

### Comparative Example 13

A polyvinyl alcohol aqueous solution (Poval 22-88, commercially available from Kuraray Co., Ltd.; a solid content of 20.0%) was applied onto the colloidal crystal layer of the laminate in Example 1 with a bar coater and dried in an oven under conditions of 70° C. for 3 minutes, and air in voids in the colloidal crystal layer was replaced with a resin component.

### <Production of Heat-Sensitive Recording Body>

### Example 56

100 parts of the aqueous dispersion obtained in Production Example 55 and 0.3 parts of Denacol EX-313 (commercially available from Nagase ChemteX Corporation, a glycerol polyglycidyl ether epoxy equivalent of 141 g/eq, and a non-volatile component of 100%) were mixed to obtain a pressure sensitive adhesive.

The pressure sensitive adhesive was applied onto the resin layer of the laminate in Example 44 with a bar coater and dried in an oven at 80° C. for 5 minutes to form an adhesive layer having a thickness of 20 μm. A heat-sensitive recording body in the form of an adhesive sheet was obtained by laminating the release surface of the release paper on the adhesive layer.

### <Evaluation of Laminate>

The obtained laminates (including heat-sensitive recording bodies) were evaluated as follows. The results are shown in Tables 10A to 12.

### [Confirmation of Voids]

When voids with a most frequent pore diameter of 10 to 200 nm were detected in the obtained laminate by a nitrogen adsorption method, it was determined that voids were present. The BJH method was adopted from the adsorption side of the nitrogen adsorption isotherm obtained by the nitrogen adsorption method, and the peak top was used as the most frequent pore diameter. For parameters of the BJH method, the standard t curve was plotted with Harkins-Jura, and a volume frequency distribution. BELSORP-maxll (device name, commercially available from MicrotracBel Corp.) was used for measurement.

Yes: voids with a most frequent pore diameter of 10 to 200 nm were detected in the colloidal crystal layer

No: voids with a most frequent pore diameter of 10 to 200 nm were not detected in the colloidal crystal layer.

### [Color Development Property]

The reflection spectrum of the laminate was measured in a wavelength range of 350 to 850 nm using a UV-visible near-infrared spectrophotometer (V-770D, Integrating sphere unit ISN-923, commercially available from JASCO Corporation). The reflectance at each wavelength was a relative reflectance measured using a standard whiteboard (SRS-99-010, commercially available from Labsphere, Inc.) with a known reflectance as a reference. Examples 44 and 56 were measured from the side of the substrate. Other examples were measured from the side of the colloidal crystal layer. For the obtained reflection spectrum, the difference (AR) between the maximum value of the reflectance derived from the structural color and the reflectance of the base line independent of the structural color was calculated. A larger ΔR indicates a better color development property. From the obtained ΔR, evaluation was performed based on the following criteria.
S: ΔR was 10% or more (very good).
A: ΔR was 5% or more and less than 10% (good).
B: ΔR was 2% or more and less than 5% (usable).
C: ΔR was less than 2% or the peak of the reflectance derived from the structural color could not be determined (unusable).

### [Storage Stability]

After the laminate was left at room temperature for 6 months, the reflection spectrum was measured in the same manner as in the above color development property evaluation. The reflection spectra before and after the time elapsed were compared and the rate of change (rate of decrease) of the maximum value of the reflectance was calculated. A higher rate of change indicates that the colloidal crystal had faded. From the obtained rate of change, evaluation was performed based on the following criteria.
S: the rate of change of the maximum value of the reflectance was less than 3% (very good).
A: the rate of change of the maximum value of the reflectance was 3% or more and less than 5% (good).
B: the rate of change of the maximum value of the reflectance was 5% or more and less than 10% (usable).
C: the rate of change of the maximum value of the reflectance was 10% or more (unusable).

### [Color Development Change During Heating]

The laminate was adhered to A4 size white paper with a tape, a square having a size of 2 cm×2 cm was heated using a thermal printer including a thermal head (PocketJet PJ-673, commercially available from Brother Industries, Ltd.) under conditions of 5 concentration sets, and image formation was performed.

Next, using YVO4 laser marker MD-V9600A including an infrared laser (commercially available from Keyence Corporation, a wavelength of 1,064 nm), under conditions of a laser power of 30% and a scan speed of 2,000 mm/sec, an image of the same square was formed.

In Example 43, both heating through a thermal head and infrared laser emission were performed from the side of the colloidal crystal layer.

In Examples 44 and 56, heating through a thermal head and infrared laser emission were performed from the side of the substrate.

In other examples, heating through a thermal head was performed from the side of the colloidal crystal layer, and infrared laser emission was performed from the side of the substrate.

The image-formed laminate was visually observed. In addition, the reflection spectra of the heated part (image part) and the non-heated part (non-image part) were measured in the same manner as in the above color development property evaluation. The reflection spectra of the heated part and the non-heated part were compared, and the rate of change of the maximum value of the reflectance (rate of decrease) was calculated, and evaluated based on the following criteria. A larger rate of change indicates that a clear color change was caused by a heat treatment.

When an image could not be formed because the colloidal crystal layer was peeled off during image formation, it was determined to be unusable. In addition, in subsequent evaluations, it was determined to be unusable.
S: the contour of the image was clear and the rate of change of the maximum value of the reflectance was 50% or more (very good).
A: the contour of the image was clear and the rate of change of the maximum value of the reflectance was 30% or more and less than 50% (good).
B: the contour of the image was clear and the rate of change of the maximum value of the reflectance was 10% or more and less than 30% (usable).
C: the contour of the image was not clear and the rate of change of the maximum value of the reflectance was less than 10% or image formation was not possible (unusable).

### [Abrasion Resistance]

The image-formed laminate with the heated side facing upward was placed on a smooth glass plate, and in the heated part and the non-heated part, each square area of 2 cm×2 cm was rubbed back and forth 40 times with a finger pad, and the occurrence of scratches and peeling was observed. Evaluation criteria are as follows.
S: no scratches or peeling (very good).
A: the scratched or peeled area was less than 1% (good).
B: the scratched or peeled area was 1% or more and less than 5% (usable).
C: the scratched or peeled area was 5% or more (unusable).

### [Substrate Conformability]

Each square test piece of 2 cm×2 cm was cut out from the heated part and the non-heated part of the image-formed laminate. The test piece was bent 20 times and the appearance on the heated side was then observed. Evaluation criteria are as follows.
S: no scratches or peeling (very good).
A: the scratched or peeled area was less than 1% (good).
B: the scratched or peeled area was 1% or more and less than 5% (usable).
C: the scratched or peeled area was 5% or more (unusable).

### [Water Resistance and Solvent Resistance]

Each test piece of 2 cm×2 cm was cut out from the heated part and the non-heated part of the image-formed laminate. The test piece was immersed in water or an ethanol solution for 1 minute and then taken out and naturally dried at room temperature, and the appearance of the heated side was observed. Evaluation criteria are as follows.
S: no scratches or peeling (very good).
A: the scratched or peeled area was less than 1% (good).
B: the scratched or peeled area was 1% or more and less than 5% (usable).
C: the scratched or peeled area was 5% or more (unusable).

TABLE 10A

| | | Example | Example | Example | Example | Example | Example | Example | Example |
|---|---|---|---|---|---|---|---|---|---|
| | | 1 | 2 | 3 | 4 | 5 | 6 | 7 | 8 |
| Color development property | | S | A | S | S | S | A | S | S |
| Storage stability | | S | S | S | S | S | S | S | S |
| Color | Thermal | S | A | S | S | S | S | S | S |
| development | head | | | | | | | | |
| change during | Infrared | S | A | S | S | S | S | S | S |
| heating | laser | | | | | | | | |
| Abrasion | Non-heated part | A | A | A | B | A | A | A | A |
| resistance | (thermal head) | | | | | | | | |
| | Heated part | A | A | A | B | A | A | A | A |
| | (thermal head) | | | | | | | | |
| | Non-heated part | A | A | A | A | A | A | A | A |
| | (infrared laser) | | | | | | | | |
| | Heated part | A | A | A | A | A | A | A | A |
| | (infrared laser) | | | | | | | | |
| Substrate | Non-heated part | S | S | S | S | S | A | S | S |
| conformability | (thermal head) | | | | | | | | |
| | Heated part | S | S | S | S | S | S | S | S |
| | (thermal head) | | | | | | | | |
| | Non-heated part | S | S | S | S | S | A | S | S |
| | (infrared laser) | | | | | | | | |
| | Heated part | S | S | S | S | S | S | S | S |
| | (infrared laser) | | | | | | | | |
| Water | Non-heated part | S | S | S | S | S | S | B | S |
| resistance | (thermal head) | | | | | | | | |
| | Heated part | S | S | S | S | S | S | A | S |
| | (thermal head) | | | | | | | | |
| | Non-heated part | S | S | S | S | S | S | A | S |
| | (infrared laser) | | | | | | | | |
| | Heated part | S | S | S | S | S | S | A | S |
| | (infrared laser) | | | | | | | | |
| Solvent | Non-heated part | A | A | A | A | A | A | A | A |
| resistance | (thermal head) | | | | | | | | |
| | Heated part | A | A | A | A | A | A | A | A |
| | (thermal head) | | | | | | | | |
| | Non-heated part | A | A | A | A | A | A | A | A |
| | (infrared laser) | | | | | | | | |
| | Heated part | A | A | A | A | A | A | A | A |
| | (infrared laser) | | | | | | | | |

| | | Example | Example | Example | Example | Example | Example |
|---|---|---|---|---|---|---|---|
| | | 9 | 10 | 11 | 12 | 13 | 14 |
| Color development property | | A | B | S | B | S | S |
| Storage stability | | S | S | S | A | S | S |
| Color | Thermal | S | B | S | B | S | B |
| development | head | | | | | | |
| change during | Infrared | S | B | S | B | S | B |
| heating | laser | | | | | | |
| Abrasion | Non-heated part | A | B | A | A | A | A |
| resistance | (thermal head) | | | | | | |
| | Heated part | A | A | A | A | A | A |
| | (thermal head) | | | | | | |
| | Non-heated part | A | A | A | A | A | A |
| | (infrared laser) | | | | | | |
| | Heated part | A | A | A | A | A | A |
| | (infrared laser) | | | | | | |
| Substrate | Non-heated part | S | S | S | S | S | B |
| conformability | (thermal head) | | | | | | |
| | Heated part | S | S | S | S | S | B |
| | (thermal head) | | | | | | |
| | Non-heated part | S | S | S | S | S | B |
| | (infrared laser) | | | | | | |
| | Heated part | S | S | S | S | S | B |
| | (infrared laser) | | | | | | |
| Water | Non-heated part | A | S | S | S | S | S |
| resistance | (thermal head) | | | | | | |
| | Heated part | A | S | S | S | S | S |
| | (thermal head) | | | | | | |
| | Non-heated part | A | S | S | S | S | S |
| | (infrared laser) | | | | | | |
| | Heated part | A | S | S | S | S | S |
| | (infrared laser) | | | | | | |
| Solvent | Non-heated part | A | A | A | A | A | A |
| resistance | (thermal head) | | | | | | |
| | Heated part | A | A | A | A | A | A |
| | (thermal head) | | | | | | |
| | Non-heated part | A | A | A | A | A | A |
| | (infrared laser) | | | | | | |
| | Heated part | A | A | A | A | A | A |
| | (infrared laser) | | | | | | |

TABLE 10B

| | | Example | Example | Example | Example | Example | Example | Example | Example |
|---|---|---|---|---|---|---|---|---|---|
| | | 15 | 16 | 17 | 18 | 19 | 20 | 21 | 22 |
| Color development property | | S | S | S | S | A | S | A | A |
| Storage stability | | S | S | S | S | A | S | A | S |
| Color | Thermal | S | S | S | S | A | B | S | A |
| development | head | | | | | | | | |
| change during | Infrared | S | S | S | S | A | B | S | A |
| heating | laser | | | | | | | | |
| Abrasion | Non-heated part | A | A | A | A | A | A | A | A |
| resistance | (thermal head) | | | | | | | | |
| | Heated part | A | A | A | A | A | A | A | A |
| | (thermal head) | | | | | | | | |
| | Non-heated part | A | A | A | A | A | A | A | A |
| | (infrared laser) | | | | | | | | |
| | Heated part | A | A | A | A | A | A | A | A |
| | (infrared laser) | | | | | | | | |
| Substrate | Non-heated part | S | S | S | S | S | S | S | S |
| conformability | (thermal head) | | | | | | | | |
| | Heated part | S | S | S | S | S | S | S | S |
| | (thermal head) | | | | | | | | |
| | Non-heated part | S | S | S | S | S | S | S | S |
| | (infrared laser) | | | | | | | | |
| | Heated part | S | S | S | S | S | S | S | S |
| | (infrared laser) | | | | | | | | |
| Water | Non-heated part | S | S | S | S | S | S | S | S |
| resistance | (thermal head) | | | | | | | | |
| | Heated part | S | S | S | S | S | S | S | S |
| | (thermal head) | | | | | | | | |
| | Non-heated part | S | S | S | S | S | S | S | S |
| | (infrared laser) | | | | | | | | |
| | Heated part | S | S | S | S | S | S | S | S |
| | (infrared laser) | | | | | | | | |
| Solvent | Non-heated part | A | A | A | A | A | A | A | A |
| resistance | (thermal head) | | | | | | | | |
| | Heated part | A | A | A | A | A | A | A | A |
| | (thermal head) | | | | | | | | |
| | Non-heated part | A | A | A | A | A | A | A | A |
| | (infrared laser) | | | | | | | | |
| | Heated part | A | A | A | A | A | A | A | A |
| | (infrared laser) | | | | | | | | |

| | | Example | Example | Example | Example | Example | Example |
|---|---|---|---|---|---|---|---|
| | | 23 | 24 | 25 | 26 | 27 | 28 |
| Color development property | | S | S | A | B | S | S |
| Storage stability | | S | S | S | S | S | S |
| Color | Thermal | S | S | A | B | B | S |
| development | head | | | | | | |
| change during | Infrared | S | S | A | B | B | S |
| heating | laser | | | | | | |
| Abrasion | Non-heated part | A | A | A | A | A | A |
| resistance | (thermal head) | | | | | | |
| | Heated part | A | A | A | A | A | A |
| | (thermal head) | | | | | | |
| | Non-heated part | A | A | A | A | A | A |
| | (infrared laser) | | | | | | |
| | Heated part | A | A | A | A | A | A |
| | (infrared laser) | | | | | | |
| Substrate | Non-heated part | S | S | S | S | S | S |
| conformability | (thermal head) | | | | | | |
| | Heated part | S | S | S | S | S | S |
| | (thermal head) | | | | | | |
| | Non-heated part | S | S | S | S | S | S |
| | (infrared laser) | | | | | | |
| | Heated part | S | S | S | S | S | S |
| | (infrared laser) | | | | | | |
| Water | Non-heated part | S | S | A | S | S | S |
| resistance | (thermal head) | | | | | | |
| | Heated part | S | S | A | S | S | S |
| | (thermal head) | | | | | | |
| | Non-heated part | S | S | A | S | S | S |
| | (infrared laser) | | | | | | |
| | Heated part | S | S | A | S | S | S |
| | (infrared laser) | | | | | | |
| Solvent | Non-heated part | A | A | B | A | A | A |
| resistance | (thermal head) | | | | | | |
| | Heated part | A | A | B | A | A | A |
| | (thermal head) | | | | | | |
| | Non-heated part | A | A | B | A | A | A |
| | (infrared laser) | | | | | | |
| | Heated part | A | A | B | A | A | A |
| | (infrared laser) | | | | | | |

TABLE 11A

| | | Example | Example | Example | Example | Example | Example | Example | Example |
|---|---|---|---|---|---|---|---|---|---|
| | | 29 | 30 | 31 | 32 | 33 | 34 | 35 | 36 |
| Color development property | | S | S | A | S | S | S | S | S |
| Storage stability | | S | S | S | A | S | S | S | S |
| Color | Thermal | S | S | S | S | S | S | S | S |
| development | head | | | | | | | | |
| change during | Infrared | S | S | S | S | S | S | S | S |
| heating | laser | | | | | | | | |
| Abrasion | Non-heated part | A | A | A | B | A | A | A | A |
| resistance | (thermal head) | | | | | | | | |
| | Heated part | S | A | A | A | A | A | A | A |
| | (thermal head) | | | | | | | | |
| | Non-heated part | A | A | A | B | A | A | A | A |
| | (infrared laser) | | | | | | | | |
| | Heated part | S | A | A | A | A | A | A | A |
| | (infrared laser) | | | | | | | | |
| Substrate | Non-heated part | S | S | A | S | S | S | S | S |
| conformability | (thermal head) | | | | | | | | |
| | Heated part | S | S | S | S | S | S | S | S |
| | (thermal head) | | | | | | | | |
| | Non-heated part | S | S | A | S | S | S | S | S |
| | (infrared laser) | | | | | | | | |
| | Heated part | S | S | S | S | S | S | S | S |
| | (infrared laser) | | | | | | | | |
| Water | Non-heated part | S | S | S | S | S | S | S | A |
| resistance | (thermal head) | | | | | | | | |
| | Heated part | S | S | S | S | S | S | S | A |
| | (thermal head) | | | | | | | | |
| | Non-heated part | S | S | S | S | S | S | S | A |
| | (infrared laser) | | | | | | | | |
| | Heated part | S | S | S | S | S | S | S | A |
| | (infrared laser) | | | | | | | | |
| Solvent | Non-heated part | A | A | A | A | A | A | A | A |
| resistance | (thermal head) | | | | | | | | |
| | Heated part | S | A | A | A | A | S | S | A |
| | (thermal head) | | | | | | | | |
| | Non-heated part | A | A | A | A | A | A | A | A |
| | (infrared laser) | | | | | | | | |
| | Heated part | S | A | A | A | A | S | S | A |
| | (infrared laser) | | | | | | | | |

| | | Example | Example | Example | Example | Example | Example | Example |
|---|---|---|---|---|---|---|---|---|
| | | 37 | 38 | 39 | 40 | 41 | 42 | 43 |
| Color development property | | S | A | S | S | S | S | S |
| Storage stability | | S | S | S | S | S | S | S |
| Color | Thermal | S | S | S | S | S | S | S |
| development | head | | | | | | | |
| change during | Infrared | S | S | S | S | S | S | S |
| heating | laser | | | | | | | |
| Abrasion | Non-heated part | A | A | A | A | A | A | A |
| resistance | (thermal head) | | | | | | | |
| | Heated part | A | A | A | A | A | A | A |
| | (thermal head) | | | | | | | |
| | Non-heated part | A | A | A | A | A | A | A |
| | (infrared laser) | | | | | | | |
| | Heated part | A | A | A | A | A | A | A |
| | (infrared laser) | | | | | | | |
| Substrate | Non-heated part | S | S | B | S | B | S | S |
| conformability | (thermal head) | | | | | | | |
| | Heated part | S | S | B | S | B | S | S |
| | (thermal head) | | | | | | | |
| | Non-heated part | S | S | B | S | B | S | S |
| | (infrared laser) | | | | | | | |
| | Heated part | S | S | B | S | B | S | S |
| | (infrared laser) | | | | | | | |
| Water | Non-heated part | B | B | S | S | S | S | S |
| resistance | (thermal head) | | | | | | | |
| | Heated part | B | B | S | S | S | S | S |
| | (thermal head) | | | | | | | |
| | Non-heated part | B | B | S | S | S | S | S |
| | (infrared laser) | | | | | | | |
| | Heated part | B | B | S | S | S | S | S |
| | (infrared laser) | | | | | | | |
| Solvent | Non-heated part | A | A | A | A | A | A | A |
| resistance | (thermal head) | | | | | | | |
| | Heated part | A | A | A | A | A | A | A |
| | (thermal head) | | | | | | | |
| | Non-heated part | A | A | A | A | A | A | A |
| | (infrared laser) | | | | | | | |
| | Heated part | A | A | A | A | A | A | A |
| | (infrared laser) | | | | | | | |

TABLE 11B

| | | Example | Example | Example | Example | Example | Example | Example |
|---|---|---|---|---|---|---|---|---|
| | | 44 | 45 | 46 | 47 | 48 | 49 | 50 |
| Color development property | | S | S | S | S | S | A | S |
| Storage stability | | S | S | S | S | S | S | S |
| Color | Thermal | S | S | S | S | S | S | S |
| development | head | S | S | S | S | S | S | S |
| change during | Infrared | | | | | | | |
| heating | laser | | | | | | | |
| Abrasion | Non-heated part | S | S | S | S | S | S | A |
| resistance | (thermal head) | | | | | | | |
| | Heated part | S | S | S | S | S | S | S |
| | (thermal head) | | | | | | | |
| | Non-heated part | S | S | S | S | S | S | A |
| | (infrared laser) | | | | | | | |
| | Heated part | S | S | S | S | S | S | S |
| | (infrared laser) | | | | | | | |
| Substrate | Non-heated part | S | S | S | S | S | S | S |
| conformability | (thermal head) | | | | | | | |
| | Heated part | S | S | S | S | S | S | S |
| | (thermal head) | | | | | | | |
| | Non-heated part | S | S | S | S | S | S | S |
| | (infrared laser) | | | | | | | |
| | Heated part | S | S | S | S | S | S | S |
| | (infrared laser) | | | | | | | |
| Water | Non-heated part | S | S | S | S | S | S | S |
| resistance | (thermal head) | | | | | | | |
| | Heated part | S | S | S | S | S | S | S |
| | (thermal head) | | | | | | | |
| | Non-heated part | S | S | S | S | S | S | S |
| | (infrared laser) | | | | | | | |
| | Heated part | S | S | S | S | S | S | S |
| | (infrared laser) | | | | | | | |
| Solvent | Non-heated part | A | A | A | A | S | A | A |
| resistance | (thermal head) | | | | | | | |
| | Heated part | S | S | S | S | S | S | A |
| | (thermal head) | | | | | | | |
| | Non-heated part | A | A | A | A | S | A | A |
| | (infrared laser) | | | | | | | |
| | Heated part | S | S | S | S | S | S | A |
| | (infrared laser) | | | | | | | |

| | | Example | Example | Example | Example | Example | Example |
|---|---|---|---|---|---|---|---|
| | | 51 | 52 | 53 | 54 | 55 | 56 |
| Color development property | | S | S | A | A | B | S |
| Storage stability | | S | S | S | S | S | S |
| Color | Thermal | S | S | S | S | S | S |
| development | head | S | S | S | S | S | S |
| change during | Infrared | | | | | | |
| heating | laser | | | | | | |
| Abrasion | Non-heated part | A | S | S | S | S | S |
| resistance | (thermal head) | | | | | | |
| | Heated part | S | S | S | S | S | S |
| | (thermal head) | | | | | | |
| | Non-heated part | A | S | S | S | S | S |
| | (infrared laser) | | | | | | |
| | Heated part | S | S | S | S | S | S |
| | (infrared laser) | | | | | | |
| Substrate | Non-heated part | S | S | S | S | S | S |
| conformability | (thermal head) | | | | | | |
| | Heated part | S | S | S | S | S | S |
| | (thermal head) | | | | | | |
| | Non-heated part | S | S | S | S | S | S |
| | (infrared laser) | | | | | | |
| | Heated part | S | S | S | S | S | S |
| | (infrared laser) | | | | | | |
| Water | Non-heated part | S | S | S | S | S | S |
| resistance | (thermal head) | | | | | | |
| | Heated part | S | S | S | S | S | S |
| | (thermal head) | | | | | | |
| | Non-heated part | S | S | S | S | S | S |
| | (infrared laser) | | | | | | |
| | Heated part | S | S | S | S | S | S |
| | (infrared laser) | | | | | | |
| Solvent | Non-heated part | A | A | A | A | A | A |
| resistance | (thermal head) | | | | | | |
| | Heated part | A | S | S | S | S | S |
| | (thermal head) | | | | | | |
| | Non-heated part | A | A | A | A | A | A |
| | (infrared laser) | | | | | | |
| | Heated part | A | S | S | S | S | S |
| | (infrared laser) | | | | | | |

TABLE 12

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Color development property | | C | C | A | S | S | C | S |
| Storage stability | | C | B | S | S | S | S | S |
| Color | Thermal | C | C | C | C | C | C | C |
| development | head | | | | | | | |
| change | Infrared | C | C | C | C | C | C | C |
| during | laser | | | | | | | |
| heating | | | | | | | | |
| Abrasion | Non-heated part | A | A | C | B | C | A | A |
| resistance | (thermal head) | | | | | | | |
| | Heated part | A | A | C | A | C | A | A |
| | (thermal head) | | | | | | | |
| | Non-heated part | A | A | B | B | C | A | A |
| | (infrared laser) | | | | | | | |
| | Heated part | A | A | B | A | C | A | A |
| | (infrared laser) | | | | | | | |
| Substrate | Non-heated part | S | S | C | C | C | S | S |
| conformability | (thermal head) | | | | | | | |
| | Heated part | S | S | C | C | C | S | S |
| | (thermal head) | | | | | | | |
| | Non-heated part | S | S | B | C | C | S | S |
| | (infrared laser) | | | | | | | |
| | Heated part | S | S | B | C | C | S | S |
| | (infrared laser) | | | | | | | |
| Water | Non-heated part | S | S | B | B | C | S | S |
| resistance | (thermal head) | | | | | | | |
| | Heated part | S | S | B | A | C | S | S |
| | (thermal head) | | | | | | | |
| | Non-heated part | S | S | B | B | C | S | S |
| | (infrared laser) | | | | | | | |
| | Heated part | S | S | B | A | C | S | S |
| | (infrared laser) | | | | | | | |
| Solvent | Non-heated part | A | A | C | B | C | A | A |
| resistance | (thermal head) | | | | | | | |
| | Heated part | A | A | C | B | C | A | A |
| | (thermal head) | | | | | | | |
| | Non-heated part | A | A | C | A | C | A | A |
| | (infrared laser) | | | | | | | |
| | Heated part | A | A | C | A | C | A | A |
| | (infrared laser) | | | | | | | |

| | | Comparative | Comparative | Comparative | Comparative | Comparative | Comparative |
|---|---|---|---|---|---|---|---|
| | | Example 8 | Example 9 | Example 10 | Example 11 | Example 12 | Example 13 |
| Color development property | | C | S | C | A | S | C |
| Storage stability | | C | S | S | S | S | S |
| Color | Thermal | A | S | B | C | C | C |
| development | head | | | | | | |
| change | Infrared | A | S | B | C | C | C |
| during | laser | | | | | | |
| heating | | | | | | | |
| Abrasion | Non-heated part | B | A | A | C | C | A |
| resistance | (thermal head) | | | | | | |
| | Heated part | B | A | A | C | C | A |
| | (thermal head) | | | | | | |
| | Non-heated part | B | A | A | B | C | A |
| | (infrared laser) | | | | | | |
| | Heated part | B | A | A | B | C | A |
| | (infrared laser) | | | | | | |
| Substrate | Non-heated part | S | C | S | C | C | S |
| conformability | (thermal head) | | | | | | |
| | Heated part | S | C | S | C | C | S |
| | (thermal head) | | | | | | |
| | Non-heated part | S | C | S | C | C | S |
| | (infrared laser) | | | | | | |
| | Heated part | S | C | S | C | C | S |
| | (infrared laser) | | | | | | |
| Water | Non-heated part | S | S | S | C | C | C |
| resistance | (thermal head) | | | | | | |
| | Heated part | S | S | S | C | C | C |
| | (thermal head) | | | | | | |
| | Non-heated part | S | S | S | B | C | B |
| | (infrared laser) | | | | | | |
| | Heated part | S | S | S | B | C | B |
| | (infrared laser) | | | | | | |
| Solvent | Non-heated part | A | A | A | C | C | C |
| resistance | (thermal head) | | | | | | |
| | Heated part | A | A | A | C | C | C |
| | (thermal head) | | | | | | |
| | Non-heated part | A | A | A | C | C | C |
| | (infrared laser) | | | | | | |
| | Heated part | A | A | A | C | C | C |
| | (infrared laser) | | | | | | |

The laminate and heat-sensitive recording body of the present invention were thin films and exhibited excellent structural color, exhibited excellent long-term storage stability, and additionally exhibited a clear color change before and after heating. In addition, in the heated part and the non-heated part, various film resistances (abrasion resistance, substrate conformability, water resistance, and solvent resistance) were excellent. Particular, the laminates of Examples 44 to 55 having a resin layer on the colloidal crystal layer and the heat-sensitive recording body of Example 56 had excellent abrasion resistance and solvent resistance.

On the other hand, the laminates of comparative examples were significantly poor in any of the above evaluation items.

### INDUSTRIAL APPLICABILITY

The laminate of the present invention is a thin film and exhibits an excellent structural color, exhibits excellent storage stability, exhibits a clear color change during heating, and has excellent various film resistances, and thus it can be used in a wide range of applications such as security devices, optical filters, display elements, optical waveguides, optical resonators, and optical switches in addition to imparting design properties to heat sensitive labels, stickers and the like.

Priority is claimed on Japanese Patent Application No. 2020-191240, filed Nov. 17, 2020, the content of which is incorporated herein by reference.

### REFERENCE SIGNS LIST

1 Colloidal crystal layer (closely packed structure)
25 2 Primer layer
3 Substrate
4 Core-shell-type resin fine particles
5 Shell
6 Core
7 Void
8 Achromatic black fine particles
9 Heated colloidal crystal layer (sparsely packed structure)
10 Matrix
15 Laminate

1. A laminate in which a substrate, a primer layer formed from a resin, and a colloidal crystal layer that develops color due to light interference are arranged in this order,
wherein the resin forming the primer layer has a glass transition point in a range of −35 to 100° C.,
the colloidal crystal layer contains core-shell-type resin fine particles and achromatic black fine particles, and has voids,
the core-shell-type resin fine particles contain a shell in a range of 10 to 150 mass % based on a mass of a core, and the shell has a glass transition point in a range of −60 to 40° C., and
the colloidal crystal layer has a thickness in a range of 0.5 to 100 μm.

2. The laminate according to claim 1,
wherein the core has a glass transition point of 50° C. or higher.

3. The laminate according to claim 1,
wherein the colloidal crystal layer contains the achromatic black fine particles in a range of 0.3 to 3 mass % based on the mass of the core-shell-type resin fine particles.

4. The laminate according to claim 1,
wherein the resin forming the primer layer has an acid value in a range of 5 to 140 mg KOH/g.

5. The laminate according to claim 1, where
in the core of the core-shell-type resin fine particles contains a structural unit derived from an aromatic ethylenically unsaturated monomer in a range of 70 to 100 mass % based on the mass of the core.

6. The laminate according to claim 1,
wherein the shell of the core-shell-type resin fine particles contains, based on the mass of the shell, a structural unit derived from an ethylenically unsaturated monomer (s-1) having an octanol/water partition coefficient in a range of 1 to 2.5 in a range of 70 to 99.5 mass % and a structural unit derived from an ethylenically unsaturated monomer (s-2) having an octanol/water partition coefficient of less than 1 in a range of 0.5 to 15 mass %.

7. The laminate according to claim 1,
wherein the core-shell-type resin fine particles contain a structural unit derived from a reactive surfactant.

8. The laminate according to claim 1, which has a resin layer on the colloidal crystal layer.

9. A heat-sensitive recording material formed using the laminate according to claim 1.

10. The heat-sensitive recording material according to claim 9, further comprising an adhesive layer.

11. A method for forming an image, comprising
heating the heat-sensitive recording material according to claim 9 to fade color development of a colloidal crystal layer.
